(19) United States
(12) Patent Application Publication
(10) Pub. No.: US 2025/0386099 A1
(43) Pub. Date: Dec. 18, 2025

(54) Intelligent Real-Time Camera Digital Gimbal System

(71) Applicant: Peter Lablans, Morris Township, NJ (US)

(72) Inventor: Peter Lablans, Morris Township, NJ (US)

(21) Appl. No.: 19/303,181

(22) Filed: Aug. 18, 2025

Related U.S. Application Data
(63) Continuation-in-part of application No. 18/827,789, filed on Sep. 8, 2024, now Pat. No. 12,425,739.
Application No. 18/827,789 is a continuation-in-part of application No. 17/866,525, filed on Jul. 17, 2022, now abandoned.
Application No. 17/866,525 is a continuation-in-part of application No. 17/037,228, filed on Sep. 29, 2020.

(51) Int. Cl. H04N 23/68; H04N 23/60

(52) U.S. Cl. CPC H04N 23/6812; H04N 23/64; H04N 23/6811

(57) ABSTRACT

A camera system has at least a first and a second camera each with an image sensor. Active areas of the image sensors of the first and second camera are determined and define an extended image space of a real-time panoramic video. A bounding box captures a fixed position in space or an object is set. The bounding box moves through extended image space. Image data determined only by the bounding box is harvested from camera image sensors and displayed within a window on a screen in real-time. Scan-line control of images sensors based on the bounding box is updated in real-time to form an e-gimbal. Steps of the e-gimbal are performed by a machine learning inference phase on a processor.

### STATEMENT OF RELATED CASES

This application is a continuation-in-part and claims the benefit of U.S. Non-provisional patent application Ser. No. 18/827,789 filed on Sep. 8, 2024, which is a continuation-in-part and claims the benefit of U.S. Non-provisional patent application Ser. No. 17/866,525 filed on Jul. 17, 2022 and now abandoned which are both incorporated herein by reference. Application Ser. No. 17/866,525 is a continuation-in-part and claims the benefit of U.S. Non-provisional patent application Ser. No. 17/037,228, now abandoned, filed on Sep. 29, 2020 which is incorporated herein by reference.

The following patent applications are incorporated herein by reference: U.S. Non-provisional patent application Ser. No. 17/472,658 filed on Sep. 12, 2021; U.S. Non-provisional patent application Ser. No. 16/423,357 filed on May 28, 2019, now U.S. Pat. No. 10,831,093 issued on Nov. 10, 2020; U.S. Non-provisional patent application Ser. No. 16/508,031 filed on Jul. 10, 2019 now U.S. Pat. No. 10,896,327 issued on Jan. 19 2021; U.S. Non-provisional application Ser. No. 15/645,545 filed on Jul. 10, 2017, now U.S. Pat. No. 10,354,407 issued on Jul. 16, 2019; U.S. Non-provisional patent application Ser. No. 16/814,719 filed on Mar. 10, 2020 now U.S. Pat. No. 11,119,396 issued on Sep. 14, 2021; U.S. Non-provisional patent application Ser. No. 16/011,319 filed on Jun. 30, 2018 now U.S. Pat. No. 10,585,344 issued on Mar. 10, 2020. All above cases are incorporated herein by reference.

### BACKGROUND OF THE INVENTION

Currently mechanical gimbals are used to assist in tracking an object or stabilize a video image recorded with a moving camera. These mechanical gimbals are separate devices and often unwieldy to carry and install. Internal mechanical gimbals covering a sufficient field of view in consumer cameras are believed not to exist, as current internal gimbals or stabilizers only cover very small deviations. Furthermore, internal mechanical gimbals are relatively expensive to build and to control and introduce additional points of mechanical failure in for instance a smartphone which is subject to many mechanical shocks and bumps. Accordingly, a novel imaging platform internal to a device that acts as a controlled digital gimbal at least in one coordinate but has fewer or no moving parts and is able to track an object in a large field of view is required.

A significant change is taking place in the technology of computerized image processing. This technology still relies heavily on algorithmic approached. However, artificial intelligence and in particular neural networks (NNs) and reinforcement learning as well as other deep learning techniques now allow processors to extract image parameters as well as image processing parameters from training data, rather than spelled out and programmed specific algorithms. This may require a gigantic number of training examples including different camera and condition settings, which may take weeks or even months of system training. By applying tightly controlled device specifications, such as virtually base cameras, housings and orientation, one may roll out many instances of trained cameras, using the same training data. Trained systems are easy to copy and may run very fast in operational conditions, off-setting the larger training and development cost.

### SUMMARY OF THE INVENTION

A scene-invariant, deep learning, such as reinforcement-learned or deep neural network trained, control system is provided for a panoramic multi-sensor imaging array, trained using high-resolution geometric ground-truth scenes and camera model parameters, in a camera system with 2 or more cameras in a fixed position with overlap in images created with the 2 or more cameras. The training is applied to achieve adaptive alignment and region-of-interest selection independent of scene content. The system is trained to create a scenery invariant extended image space controlled by camera parameters, based on learned one or more image sensor edges that determine scan-line limitations of individual image sensors. A real-time panoramic video image is formed by combining image data harvested only from image sensor regions defined by learned scan-line limitations. An initial preferred image capturing window within the extended image space is set and associated with a position in space of the camera system. The cameras system may move and computes or determines by deep learning where the image window will move to in extended image space as a result of the camera system movement. The camera system is trained by deep learning to apply scanline settings to individual image sensors to scan only image sensor areas to generate image content inside the moved camera. In one embodiment a capturing window is based on an object and/or a location. In another embodiment the capturing window is associated with a moving object. Scan-line limitations set in an image sensor is updated real-time and at least within a video-frame period. Technical components include training dataset with high-resolution panoramic ground truths containing detailed line/curve geometry and illumination variations; does not depend on semantic scene features (like people, vehicles, etc.). Simulation environment includes modeling physical camera parameters (focal length, exposure, shutter, noise); and providing camera-specific observations and feedback. Neural Policy for learning to align sensors parameters, set ROIs, and control image acquisition based solely on internal camera parameters and learned spatial models. Deployment behavior, at runtime, system receiving camera parameter inputs (not scene content) and outputs aligned ROI commands for each sensor. No need for scene-dependent feature detection or inference. Scene-invariant e-gimbal where ROI updates simulate camera panning/tilting across stitched views—not based on objects in the scene, but on geometric continuity and internal consistency. In another embodiment a capturing window is based on tracking an object for instance with KCF tracking.

The cameras may be attached to a common platform, which may be a housing of a camera system or a platform, for instance a movable platform inside a housing. Preferably, no matter how the platform or housing are constructed, the two or more cameras are placed in a fixed position in relation to each other. Or generally, the two or more cameras are in a fixed position relative to a first camera. In that sense all cameras experience the same movement such as translation and rotation such as pitch, yaw (pan) and roll. For convenience, the structure that holds the cameras in a fixed position is called a platform herein.

One aspect of the present invention presents novel methods and systems for a processing instruction based camera platform internal to a housing of a computing device controlled by a programmed processor with input by positional and/or orientation and/or inertial sensors part of a camera system to keep the camera orientated to a point in space while the computing device that holds the camera on the rotatable platform may be moving or itself is in a fixed position while an object that is to be captured by the camera is moving, or both the camera device and the to be recorded object and or scene may be moving.

The inventor's prior work (e.g., US20250013141A1) discloses a system for multi-camera alignment and ROI control using conventional image processing techniques. While effective within calibrated and controlled environments, such systems depend heavily on scene content, deterministic alignment logic, and often require manual reprogramming or recalibration in the face of environmental drift, optical variation, or unexpected input conditions. Aspects and embodiments of the present invention overcome these structural limitations by replacing scene-dependent logic with a reinforcement-learned policy trained on high-resolution geometric panoramas and camera model parameters. As a result, the system becomes content-invariant, self-correcting, and capable of robust, flexible deployment without ongoing manual tuning. This constitutes a significant departure from prior deterministic methods.

As a training model one may use sets of different artificial sceneries with high detail content such as lines, curves, and shapes, distributed over a large canvas that forces the cameras system to break up the image and align its parts based on camera or camera related parameters rather than content. To prevent over-fitting as is known in the art, one may generate at least a 1,000 different sceneries with detailed content. One embodiment may use for instance 100 carefully designed different sceneries with high details in expected transition or overlap areas. These images or sceneries at the same time form a well-defined ground truth in a deep learning environment.

One may then generate random sceneries from a set of pre-determined shapes, lines curves and the likes. One may use a random or pseudo random procedure to first generate a random set of shapes and a procedure to place these randomly determined shapes randomly on the canvas. One may use a 900 thus randomly created sceneries as training and ground truth images. One may use a large or very large video screen like 3 by 3 or even 5 by 5 meter or bigger to present the training sceneries. This allows for almost limitless number of training sceneries display. One may apply a two-step training model, particularly in the context of reinforcement learning for robotics and computer vision. It may be commonly known by the term “sim-to-real” (simulation-to-real-world) transfer. One may apply high-fidelity simulations that enter the image data directly into the training system without a need for displaying images on a screen.

However, a model trained purely in a perfect, noiseless simulation may fail when deployed on a real camera. This performance degradation may be called the “reality gap”. The gap exists because simulations cannot perfectly capture all the complexities of the real world, such as: sensor noise: All physical sensors have some level of random noise. Physical properties: Minor discrepancies in mass, friction, and elasticity. Actuator lag: delays in how a motor responds to a command. And lighting and optics: subtle variations in light, reflections, and lens distortions, for instance. A Two-step approach to bridge the gap. Simulation pre-training: A first step is to train the policy in a simulation environment. This is where the model learns the core task, such as the geometric alignment and region-of-interest selection you described. This step is highly efficient because: Data generation: thousands or even millions of training episodes can be run in parallel, far faster than real-time. Perfect ground truth: The simulation provides precise, unambiguous feedback and rewards. Safety: The model can fail and “crash” without any physical damage. Then apply Fine-tuning/domain randomization: A second step is to adapt this pre-trained policy to the real world. This is where a few different techniques are used, and your idea of fine-tuning with real camera data is a common one. Other methods include: domain randomization: during the simulation training phase, researchers intentionally randomize key simulation parameters (e.g., lighting, textures, camera noise, sensor latency). This is to train the policy on a wide range of different “simulated realities” so that it learns to be robust and generalize to the specific, unknown parameters of the real world.

Fine-Tuning: The pre-trained model is then fine-tuned with a small amount of data from the real hardware. This process uses the real camera's data to make minor adjustments to the model's weights, adapting it to the sensor's specific characteristics and imperfections. System Identification: This involves using a small number of real-world trials to precisely identify the parameters of the physical system (e.g., sensor noise models, camera calibration) and then retraining or fine-tuning the model using a more accurate simulation.

A system is trained by machine learning to create a combined image from multiple cameras that are preferably manufacturing-wise identical. Or if/when they are different from each other in a single system, are used in a similar configuration in copies of a trained system. Cameras are arranged in a housing, preferably in a fixed way, so that their images have overlap. By disregarding overlap regions in images one may form a panoramic image from combined or stitched images. The stitching as a separate processing step is time intensive, rendering real-time panoramic video at least unpractical and often impossible. In accordance with one or more aspects of the present invention, so called active areas of individual image sensors are determined, so that independent of scene content a panoramic image is formed from combining image data harvested only from image sensor areas that have no or no substantial overlap image data. Combining the harvested image data creates directly a panoramic or substantially panoramic image and enables very fast combining operations and thus real-time video.

In accordance with one or more aspects of the present invention, active areas that are independent of scenery content may be harvested by setting a scan line control in individual image sensor control devices. A scan line is in a grid of photo-diodes for instance, a begin and and end-point in a row or column of photodiodes that will be read. By setting correct begin and end points of scan lines, each image sensor provided the exact image data to form direct a panoramic image. One may call such a structure of programmed scan lines a device that creates and extended image space.

In one application an object caught within an extended image space of an above camera system may appear to be a moving image object when the camera is moving and/or the actual object is moving in real space. In accordance with one or more aspects of the current invention, the extended image space is calibrated or learned/trained with actual space. So in one embodiment knowing a physical location of cameras/object combination determines an object image position in extended image space. In accordance with another embodiment a know location in extended image space is mapped to a physical location.

In accordance with one or more aspects of the present invention a location of an object due to a moving cameras and/or a moving object in extended image space is known. A window or bounding box of fixed size may be created around the object and only image data inside the bounding box or window is displayed on a display, for instance. This creates a stable image, for instance a stable video image, of an object that appears to be=moving in extended image space.

In accordance with one or more aspects of the present invention, corner coordinates of a bounding box in extended image space are determined and are converted to corner coordinates in photodiode grids of individual image sensors of the camera image sensors. The scan line parameters of individual image sensors are programmed to scan region of interest determined by these corner coordinates. Accordingly, each image sensor will provide the image data required to create the image within a bounding box. This prevents the need to process all image data of an extended image space. In accordance with one or more aspects of the present invention, the scan-line ROI instructions are updated as required at least per new video frame in a series of video frames. This effectively creates a digital or electronic e-gimbal without moving mechanical parts that operates real-time for video imaging.

### BRIEF DESCRIPTION OF DRAWINGS

FIGS. 1 and 2 are diagrams of a camera for panoramic and/or images in frontal view in accordance with one or more aspects of the present invention;

FIG. 3 illustrates a composite image created in accordance with one or more aspects of the present invention;

FIGS. 4 and 5 illustrate in diagram a camera in accordance with one or more aspects of the present invention;

FIG. 6 is a diagram of a panoramic camera system in accordance with one or more aspects of the present invention;

FIG. 7 illustrates in a diagram an e-gimbal in accordance with one or more aspects of the present invention;

FIG. 8 illustrates schematically an image sensor/lens module in accordance with one or more aspects of the present invention;

FIG. 9 illustrates schematically yet another image sensor/lens module in accordance with one or more aspects of the present invention; and

FIG. 10 illustrates a logical structure of machine learning in accordance with one or more aspects of the present invention.

### DETAILED DESCRIPTION

A known way of creating panoramic images is combining or stitching or processing of image data generated by two or more cameras. Basically, two or more cameras each take an image of a scene. Usually fully developed images (usually demosaiced) are generated, making sure areas of overlap in the images of the scene exist. Images are then stitched together by a processor using software to find common points in areas of overlap. The software then uses image data of one camera and drops overlap data (which was only used to determine stitch or connecting lines between images) and generates a combined image that preferably gives an impression of a single continuous panoramic image of the scene.

In general some distortion and color mismatch may take place which may be corrected by known computer operations. While high quality still images may be generated, the processing time required by a processor to generate a panoramic image by this approach of image stitching is significant. For that reason, this “stitching” is commonly used for photos or still images. It is generally not used on for instance smartphones to generate panoramic video. Using stitching software to generate real-time panoramic video images currently does not exist as existing processors are not powerful enough to generate real-time video images from multiple cameras on a smartphone. The inventor on the instant aspects of the present invention as disclosed in this specification has invented a way to generate in real-time a video image on a smartphone from multiple cameras on a smartphone.

Real-time is this context is a display speed of at least 10 frames per second. This rate is used as a minimum wherein a human viewer would rate the video image still as a movie rather than a set of consecutively discernable still images. One can find on the Internet web like Youtube several examples of video at different frame speeds. For instance at https://www.youtube.com/watch?v=2Ds7EcJ21a4 which is incorporated herein by reference. At 8 Hz one will see a jerky movie. At 10 Hz it is slightly less so and the human mind will basically see a movie. At 15 frames per second the image appears to be a real movie and at 25 frames per second there is no doubt that at all that a movie or video is being watched. The experience also depends on the size of a display and inherent latency of pixel change. So, when teaching real-time video herein at least a frame rate of 10 frames per second is intended, more preferably a frame rate of at least 15 frames per second, more preferably a frame rate of at least 25 frames per second of a scene and more preferably at 50 frames per second or higher.

An underlying inventive concept which limits a load on processing capability is to limit the number of pixels that have to be processed by a single processor and/or a core or thread of a processor. In current digital camera technology no actual single panoramic image created from multiple cameras to start processing from, (as a type of proto-panoramic image) generally exists. A reason for that is that in current technology overlap of image data has to be evaluated by image processing to determine a stitchline between different images. In practice this often means that all image data of a camera sensor, which may be a CMOS or a CCD sensor, is harvested, usually is demosaiced to merge or process all separate data pixels into a presentable image and then start the, processor intensive, overlap detection and merging of images.

A distinction is made herein between a pixel or picture element, which is a data element representing a basic unit of an image when adequately translated or converted to a visible picture element on a screen, and a physical picture element on an image sensor. A physical picture element on an image sensor like a CMOS element is a light intensity sensor that detects light and provides as output one or more signals that represent the intensity, commonly and ultimately as a digitized signal as a binary word for instance. By using appropriate filters one may detect for each basic physical picture element (or pixel sensor) intensity of Red, Blue and Green light and provide an RGB pixel related output. A popular format of physical images sensors is the Bayer filter format as explained in https://en.wikipedia.org/wiki/Bayer_filter which is incorporated herein by reference. Bayer pixels are a set of at least 3 sensors each with a specific filter (usually Red Green Blue or RGB) from which in combination all other colors may be assembled. Variations are well known. Forming a usable image from a Bayer mosaic, requires demosacing, forming a single color pixel from a Bayer mosaic. Demosaicing may involve additional steps, like interpolation and/or blending and the like. Demosaicing of image data of different cameras may create post processing artifacts that may be difficult to remove.

One of several inventive concepts in the current disclosure is to determine upfront, before even harvesting all relevant image data, which may include addressable physical pixel elements on for instance a CMOS image sensor, are required to create a panoramic or wide-view image. That is: only data generated by physical pixel elements in a pre-defined “active” area of an image sensor are used. All data, generated by physical pixel elements up to a defined merge line, are used. Past the merge line, data generated by physical pixel elements in an active area of an image sensor in a corresponding image sensor of another camera, is used to create the panoramic image. When the active areas are selected and implemented correctly, the harvested image data from the respective image sensors already form a basic or proto panoramic image and no merge or stitch line has to be detected. This has at least one advantage over existing digital image sensor based camera technology. One advantage is that a physical stitch-line is determined on a sensor. That is, only data on a pre-determined side of a stitch-line on a first image sensor is required to be processed and to be merged with image data harvested from a corresponding side of a stitch-line of a second image sensor, to directly create on a memory stored image data. Such image data is stored in a manner that when read as for instance image lines, an image line of a read image is a combination of two image lines of harvested image data of at least 2 image sensors at predetermined sides of respective physical stitchlines. Preferably, the proto-panoramic image is stored in pre-de-mosaiced format. This means that in memory, even prior to further demosaicing for instance, stored image data exist that fundamentally represents an extended or panoramic image, created from two or more image sensors and/or two or more cameras. What is required to be done in old technology by a processor is basically done by just collecting and storing data from multiple image sensors.

The areas of image sensors from which image data is harvested are called “active sensor areas” herein. This means that only data from those predefined areas, determined for instance by a physical stitchline, are stored in a dedicated memory or part of a memory and processed. In general, a whole useful sensor area of a digital image sensor is available for obtaining image data. However, in accordance with an aspect of the present invention, only image data from predefined active sensor areas are harvested and stored in a memory as an image, preferably in contiguous form, so that the stored image data when being read represents a panoramic image or a substantially panoramic image.

One may create a map of an image sensor and read or scan only specific regions of interest or part of scanlines into a memory, wherein ultimately the memory contains contiguous data that in its entirety forms a combined or stitched or panoramic image frame. The direct mapping of data into contiguous data is likely the fastest way to create a contiguous image preferably in raw image data, but using demosaiced data will work also. One may also use an intermediate memory wherein all image sensor data is stored and conditions of “active areas” are imposed so and only “active area data” is copied to a next memory in contiguous form. This way allow additional intermediate processing steps.

In principle, the image data harvested from active image sensor areas may be perfectly merged so that a read out (and demosaiced) image looks like a panoramic image. There may still be effects that may require correction, like color correction, blending and possibly warping to address edge distortion. However, in principle the edges of the images of the active areas should match well, with no or limited need for correction in overlap. The finding of overlap points or stitchline is one of the most expensive (in processor time) processing steps in generating a panoramic or stitched image by image processing. This step is circumvented or dramatically reduced by defining active areas as described above. The active areas may be defined as stored parameters for use by a processor as part of an operational instruction.

With high image resolutions, it may be that over time a slight mismatch between active areas occurs, for instance by temperature or air-pressure variations. This may require an adjustment of parameters, which may be achieved by conducting, prior to generating images, a calibration step that applies overlap detection and/or stitching procedures and, based on a known map of each of the sensors, determines and then stores new and updated active area parameters. In one scenario an intermittent and carrying small mismatch of active areas may occur. In that case a processing step may be included that performs overlap determination. However such a mismatch is limited in size and will be at most a distance correction of 25 pixels, more preferably of at most 15 pixels, yet more preferable at most 10 pixels and yet more preferable at most 5 pixels. Such a variation most commonly will be a linear shift which when detected can be rapidly applied to all pixels to correct in real time a variation in overlap. Because of the limited search area for overlap, this rematching can be done very fast and is much faster than custom image stitching. However, taking into account the possibility of a need for correction one may store image data that is slightly larger than a required minimum number of pixels. In that case one may call the stored harvested image data from slightly larger areas a proto-panoramic image. That is: one or more relatively rapid processing steps may be applied to remove noise like variations in merge-lines.

The stored proto-panoramic image represents always a panoramic or an almost panoramic image with possibly a slight mismatch in overlap as explained above. The proto-panoramic designations pertains exclusively to raw image data. When demosaiced or as examined pre-demosaicing, it may become apparent that other corrections may be required, as stated above.

Thus a proto-panoramic image consists of image data that is harvested exclusively from active image sensor areas, with potentially a small margin of a strip or area of a width of maximal 25 pixels but preferably not greater than 10 or even 5 pixels stored and wherein the harvested image data from an active area including a small margin is smaller than a useful image sensor area of a camera. It is also noted that stored harvested image data from active sensor areas into a memory as a proto-panoramic image does not exclude using image data that is outside an active area including a margin. For instance image data outside an active area may be sampled and stored and used for instance for color correction or determining of warp parameters. The processing of these data may be performed in parallel and even with some delay, as it may be assumed that conditions with one, a couple or even 5 frames will not dramatically change parameters.

Standard image sensors are for instance read in lines of data and the entirety of an image sensor exposed to image light may be considered the “active area.” However that is explicitly not what is intended in the current disclosure with the term “active area” of an image sensor. An active area of an image sensor is an area smaller than the entire area of active pixel elements on an image sensor able to generate image data, which may be called the useful image sensor area, or exposable image sensor area. For instance an “active area” on an image sensor may be determined by a defined line on an image sensor that separates one first area of the image sensor from another second area on the image sensor. Only image data of one of the first and second areas will be harvested and stored on a memory as part of a panoramic image. The data of the other area will not be part of the panoramic image and will not be processed as part or initial part of the panoramic image as for instance happens in image processing stitching. The “active area” of an image sensor is explicitly smaller than a “useful area” of an image sensor, a useful area being an area of an image sensor with physical pixel elements that is exposed to light when a shutter is opened.

By limiting the data that have to be processed, basically by circumventing the whole step of processor based finding of overlap and finding common stitching points, the processor has to perform fewer time consuming steps and can complete, even a rough, panoramic image by merely merging data from predetermined image sensor areas or smaller “active areas” as how they are designated herein.

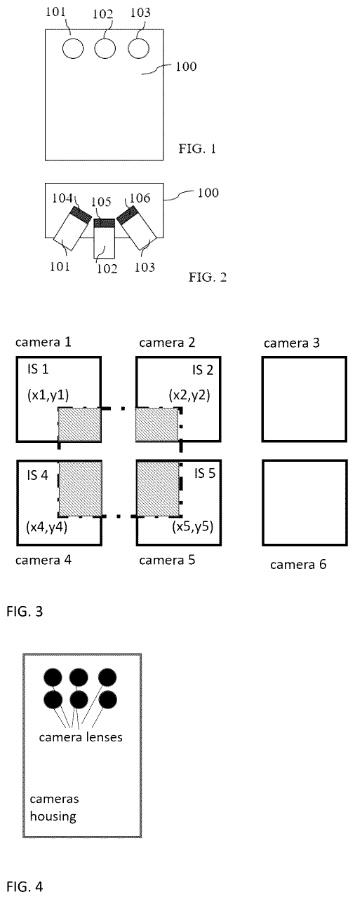

FIGS. 1 and 2 illustrate a panoramic camera that creates a real-time video panoramic image. A body 100 in FIG. 1 contains 3 fixed cameras 101, 102 and 103 of which the lenses are shown in front side view. The three cameras will generate 3 images with overlap of a scene. By determining active sensor areas as explained above one may generate a panoramic image. In this case a horizontal panorama. It is to be understood that one may add additional cameras or use just 2 cameras. One may also extend the panorama in vertical direction by adding one or more rows of cameras above or below the row 101, 102 and 103. FIG. 2 illustrates an above cross-sectional view of camera body 100 with cameras 101, 102 and 103. One can see that the cameras are orientated under an angle to each other, allowing some overlap of generated images. Also image sensors 104, 105 and 106 of the respective cameras are illustrated. It is noted that only a schematic outline of the set-up is provided. All required connections, controls and details are omitted as not to crowd the schematic. However all these details are fully contemplated and should be assumed. Also size and placement and angles in the drawings are not accurate and are in fact exaggerated to bring across the basic idea and should not be interpreted as an engineering schematic.

There are several ways to capture or harvest image data from a smaller “active area.” One is by setting scan line sizes and/or orientations. In most cases one may assume a horizontal alignment of image sensors of multiple cameras in a single frame. In that case an image line in a panoramic image is a combining or merging of active (smaller than completely available) lines of image data into a memory. One may set the scanning of a line that has k pixel elements in an array of physical sensor pixel elements from, as an illustrative example, from kstart to kend wherein the total length of the line of pixel elements is ktotal and ktotal>|kend−kstart|. As an illustrative example, an image sensor may have rows of 1280 physical pixel elements and 1024 of these rows in a 1280 by 1024 pixel elements in an array of physical pixel elements. A physical pixel elements may be a Bayer arrangement of 4 photodiodes as is known in the art. Assume that the total usable and storable image sensor area is 1280 by 1024 pixels.

In one arrangement 3 aligned cameras are used to capture a horizontal panoramic image of a scene. The required overlap between individual images may be set at minimum of 10% up to 30% in area. There are different reasons for this amount of overlap. Usually it depends on the applied stitching software. It also depends on the quality of the lenses, as lens distortion is often worse at the edges of an image. Most image distortion may and can be corrected by image software. For illustrative purposes assume that a minimum of 10% of overlap is required. In this case, forming a horizontal image from data harvested from 3 sensors with 10% overlap, one may use one image with a stitch or merge-line at 90% of a first image sensor and with an effective scan length of its pixel line of 90% of 1280 pixels.

The first camera would thus only have an active pixel line of 90% of 1280 pixels or for instance kstart=1, kend=1152 and ktotal=1280 and thus ktotal>| kend−kstart|. For a middle camera, the image scan-line would drop 10% overlap both at the begin and the end and for instance kstart=116 and kend=1149. The third (outside) camera would lose the first 10% of its overlap area and has an effective active pixel line with kstart=122 and kend=1280. In the above example it is shown that start and end position of the scan line may differ. This is because the required overlap is determined in one or more calibration steps. In a calibration step, cameras may already be fixed an aligned horizontally in a single body. The entire panoramic camera is pointed at a calibration set with sufficient marks and at predetermined distance. At that time it is determined what the correct overlap is to create a seamless merged image or a merged image that is satisfactory as a panoramic image. This determines the merge lines from which one determined the start and ending position of the scan lines.

This may be stored as camera parameters that are activated during actual recording of images. There may be environmental parameters like humidity and/or temperature and/or air pressure that affect the required settings. The settings may be associated with parameters and stored in a memory and may be activated based on measured circumstances. Manual adjustment may also be activated. That is, during start-up or after noticing inaccuracies a user may manually adjust the overlap and thus the scan line parameters by pointing the multi-camera system at a scene and with for instance a manual control or knob or menu element on a touch screen, adjust the overlap. This can be done by pointing at a scene, and in a calibration state adjust the image on a screen so an optimal panoramic image is formed. The thus determined scan line positions may be activated for a period of use. While a manual adjustment is possible, one may also use classical stitching software to find optimal overlap between images and let the software determine optimal scan line sizes and positions. Once the software on a processor has determined the optimal scan lines and scan start and end positions, these scan-lines are activated as well as how the images generated by active areas depending on the scan lines are stored and combined in memory, so that the stored image is substantially and perceivably a panoramic image.

For instance, prior to adjustment a camera may create a panoramic image line instance camera 1: kstart=1, kend=1152; camera 2: kstart=116 and kend=1149; and camera 3: kstart=122 and kend=1280. Changing parameters may require more overlap, for instance by 6 pixels at one side and 9 pixels at the other side. This means that the total active area has become smaller. Simple rules how to store the image data are derived from the new sizes and positions of the scan lines. In general one should reserve room at the ends of the beginning and ending of the first and third camera to account for changing overall size of the panoramic images. For instance, one may assume that the total size of an image will not vary more than 50 pixels at each side and use those conditions to determine the size of the scan lines and the memory to store the image data as substantially a panoramic images.

For illustrative purposes, only image extension by adding horizontal cameras has been illustrated. One may also create panoramic images in vertical direction applying the same approach as above. However, in that case one has to take into account also the vertical overlap that is required. Thus system parameters have to determine optimal overlap and determine the vertical positions in a physical pixel array where pixel line scanning will begin and end to create horizontal merge lines of active areas.

Now referring to FIG. 6. Using current inertial and other sensors in a camera-system such as a smartphone, allows to determine a deviation of a pointing direction from an initial pointing (center) direction. This is illustrated for horizontally extended panoramic images. The camera system has at least 3 cameras with corresponding active image sensor areas 1401, 1402 and 1403 that creates an optical space of image sensor combination 1400 and a corresponding image space of a panoramic image. One may consider constructing the panoramic image from a central point 1406. The camera looking directly to a center point 1404 focused on an object records an absolute pointing direction 1408 in active area 1402. Moving the camera keeps the object within the field of vision of the panoramic system. But now the image center has moved to position 1405 in active area 1401. Assuming that the object has not moved and the camera system has rotated around an axis, the object still has the pose recorded as 1408, but the object appears to be in position 1409. While the image appears to have rotated left from 1408 to 1409, the camera has actually rotated right determined by the angle between pointing direction 1408 and 1409. To construct the correct image, one has to use the pixels in 1401 determined from the negative rotation of the neutral position of the camera to the new position as determined by the inertial sensors, for instance. So if the camera has a yaw of 17 degrees right, one has to look for image data by rotation of the calibration space of 17 degrees left.

A user may set a size of an extracted image 1405 as a window size. As default an image size may correspond to a screen size. However, a user may create a size of a window for instance by expanding or diminishing a size of a rectangle on a touch screen.

A multi-camera system as taught herein may have enabled a preferred recording position or recording pose and extract an image corresponding to that preferred pose even when the center of the system is not pointed in the preferred direction or pose. A user may switch off the system or walk away, with the system active, or may go to a new location. Anyway, a system may activated to recall a preferred location of an object, and/or a preferred pose or pointing direction of the camera system. A processor of the system may determine new coordinates of a system's location and based on the previous location and/or pose and/or a known or estimated position of the object determine one or both of 1) the required pose of the camera system to capture the object in the new location; 2) if a current pose of the camera system places the desired object within a field of view of the camera system and 3) provides guidance, for instance with visual markers on a screen, how to move the camera system to place the object within the field of view of the camera system. In one embodiment of the present invention an object may have a GPS or location device that provides location coordinates, including an altitude to the camera system, preferably through a wireless connection. This enable a camera system as disclosed herein to compute a pose that places the object in it field of view. It is not needed to center the camera system on the object. A marker, like a circle or a rectangle or other icon or shape, may change color indicating if an object is inside a field of view. For instance a shape like a rectangle may be red when an object is outside a field of view, turn orange when closer to field of view but still outside, blue turning green when the object is inside a field of view and is moved to a center. This approach is beneficial when an object's location is known but for some reason not visible, obscured by another object, hard to recognize because of size, or is lost for recognition in a plurality of objects.

This illustrates how with a panoramic active area image sensor construction and a calibration method one may reconstruct the correct image of an object on a screen smaller than the total panoramic image. As long one keeps an object sufficiently within a field of view of the panoramic camera, one may reconstruct a smaller but correct image of an object even with substantial movement of the camera system. One is reminded that image overlap is just that, image overlap. Not sensor overlap. A figure like FIG. 6 is merely a representation of a physical situation. One may also extend images in vertical direction. And apply a similar approach. Furthermore, certain distortion may be diminished by using curved image sensors instead of flat image sensors. Curved image sensors are taught in Guenter et al. Highly curved image sensors: a practical approach for improved optical performance, https://doi.org/10.1364/OE.25.013010 which is incorporated herein by reference. Sony Corporation has been cited to produce curved image sensors.

It was already disclosed herein that preferably one uses in the individual cameras a curved image sensor, for instance as provided by Curve-ONE S.A.S. of Levallois-Peret, France and as marketed on https://www.curve-one.com/which is incorporated herein by reference. The use of curved sensors has several benefits. It allows automatic correct placement of the sensors for the panoramic pivot point. Furthermore, the curved sensor relieves some of the projective distortion on an otherwise flat sensor and allows for less expensive and compact lenses that cause less distortion. The concept of curved sensors is pursued by different organizations and one description may be found in U.S. Pat. No. 11,848,349 to Keefe et al., issued on Dec. 19, 2023 which incorporated herein by reference and is developed by HRL Laboratories, LLC of Malibu, CA. A curved image sensor is preferably a spherically curved image sensor.

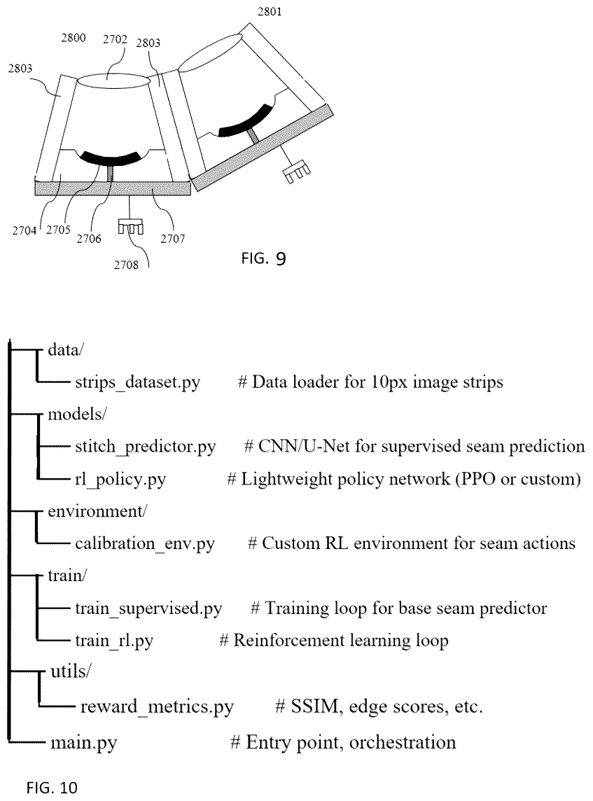

The use of curved image sensor in accordance with an aspect of the present invention s applied in a modular build of an e-gimbal system. This is illustrated in FIG. 8. FIG. 8 shows two image sensor/lens modules: 2700 and 2701. These modules are identical and only 2700 is described in detail. FIG. 8 2700 provides a very schematic representation to highlight some shapes and parts, but is of course not an engineering schematic and measurements or shapes are not representative of the actual module, as one of ordinary skill understands. The sensor/lens module has a housing 2703 that holds all elements of the module. The shape of the housing is an inverted flatted pyramid or mastaba, with sloping sides of which the angles are carefully determined so images generated by the sensors have sufficiently overlap. The material of the housing may be ceramic or metal or a combination there of. However, the inside is preferably not reflective and may be treated with a coating to absorb any light coming through the lens 2702. For illustrative purposes 2702 is represented by a single ellipsoid, but in practice the lens may be a composite lens with several elements and positioned relatively much closer to the sensor 2705 than depicted herein. Lens 2702 is held in place by a ring structure 2710 which attaches the lens to the housing. On the bottom of the module is a carrier 2704 which may be a ceramic carrier, similarly with preferably non-reflective properties. On the carrier which has a hollow preferably spherical shape is placed, possibly through known depositing techniques a curved image sensor 2705 which corresponds to optical properties of lens 2702. In general one does not want a schematic with auxiliary parts absent or hanging or not provided. The harvesting of the image data is controlled by electronics, processor, memory as needed and including power source all as 2707. For convenience this is shown connected to the bottom of the carrier via connection 2706 and connector 2708 to connect the sensor control and output to further required equipment. Other configurations are possible and are fully contemplated. for instance some solutions show a connection/control unit next to the curved sensor 2705 which may make connection easier. Another configuration in shape is illustrated in FIG. 9 with modules 2800 and 2801. All components in 2800 and 2801 are identical to those of FIG. 8. Only the housing 2803 is different in shape and looks like the inverse of 2703. Furthermore wherein slanted housing 2703 and lens or lens system 2702 from an above view are identified. By selected the correct shape of the slope the modules may be stacked side by side, creating for instance a unit that covers a field of view of 180 degrees or even greater. The lens 2702 may be held to housing 2703 with a ring not shown, being bonded or otherwise attached, which is assumed but not shown as not to overcrowd the schematic representation.

One may provide the housing of the camera modules such as 2700 with outside and inside oriented ridges, deliberately positioned so when two modules are merged the two sets of complementary ridges automatically align the modules, which may then be bonded or fixedly attached to a common housing. One may provide the matching ridges a small amount of tolerance of fitting. Then using high accuracy mechanical manipulators or robotic arms one may accurately align the connecting modules thus creating the required overlap in the images in accordance with predefined active areas. This is where the connectors 2708 are helpful. These may be connected to a processor and based on the generated image data, the robotic arms will hold the modules in a desired position to achieve the required overlap and active areas. One may say that the camera modules with the help of processors may be assumed and are called herein to be self-aligning.

In accordance with an aspect of the present invention, only a part of the entire possible image space is displayed on a display or screen. By providing a display window which may be called a gimbal-window or e-gimbal of a size smaller than the complete image space, it seems a static image display of an object. In fact it may be a display of different parts of the entire image space in a video image. It will give the impression of a static scene and thus the display method works like an gimbal. But not a mechanical gimbal, but rather a digital or e-gimbal.

The e-gimbal is schematically illustrated in FIG. 7. The arrows in FIG. 7 are identified as θpan1, θpan2, θpitch1 and θpitch2. A camera, which may be a multi-camera system in a single body with fixed positions of the individual cameras. Each camera has a “standard” image space, for instance a 4:3 image aspect ratio, or something like 1280 by 720 pixels or higher resolution. In general a 4:3 aspect ratio or close to it is common. FIG. 7 illustrates in a composite drawing 2600 an image space 2601 formed by pre-set active areas of 2 or more image sensors, for instance. With 3 rows of 3 cameras one still has (of course) a 4:3 aspect ratio, but now with an image space 2600 that is over 9 times as large as the smaller standard image space 2602 of a single camera and/or camera display. Assume a moving object 2603 captured in centered window 2602. Thus a standard display displaying image space 2602, shows the object 2603. Assume the object 2603 is static but the camera is rotated to the right under a panning angle θpan1. Which appears as if the object has moved to the left. The object thus has left window 2602 and if displayed on a display, it would not show the object. In fact the object 2603 is now in image space defined by window 2604, wherein the window 2604 preferably has the same size as 2602. A similar effect occurs when the camera system pans to toe left and the object appears to the right under angle θpan2 and is now in image space in window 2605. Similarly, when the camera is rotated up, it seems as if the object moves to window 2608. And if the camera system is rotated down and left, under angles θpan2 and θpitch1 it appears if the object has moved to window 2606. Also a window 2607 is shown which is result of rotation θpan1, θpitch2.

In order to create a window in the correct position of the extended image space one needs to associate a rotation of the camera in physical space with a correct and corresponding movement or rotation in extended image space relative to a center point. In one embodiment a translation table may be created wherein one steps through all possible (one-pixel) rotations and associate each step in image space with a physical camera rotation and store the conversion in a look-up table. One may also determine projective relations between rotation and image space. The matching of physical rotation relative to a neutral center over many positions appears to be a task that may be performed by deep learning with a neural network application. Because preferably identical individual cameras are used the calibration between the physical space rotation and position in extended image space has only to be once at a controlled laboratory scale, using large sets of training data. However, the control application may be used in many identical implementations.

In accordance with an aspect of the present invention, preferably, in an image sensor a scan mechanism is available that is programmed to determine a rectangular scanning area of an “active area” inside the total available sensor array. In such a system one may program an active scanning area inside an image sensor and store in a memory in an appropriate order only the imaged data from the scanned area. One way to do that is to use shift registers to read partial lines and use related horizontal and vertical line address decoders as taught in U.S. Pat. No. 6,900,837 to Muramatsu et al. issued on May 31, 2005, which is incorporated herein by reference.

Other ways to create contiguous image data representing a panoramic image are possible and are fully contemplated. For instance one may read all data from an image data line, but only store the data that represents the active area. A mapping rule that stores only image data from active image sensor areas in memory that may be read as a contiguous image is also contemplated. Yet another approach may include immediate data mapping between two memories, wherein a second memory contains only the data generated by active areas.

The above illustrates different ways to create stored data that in essence represents a panoramic image. This takes care of overlap issues. However, there may be other issues that need to be resolved. For instance the above may be performed on raw image data that has not yet been demosaiced. Demosaicing may include interpolation that smooths away some imperfections. It may be that different positions of cameras in one body may impose visible differences for instance in lighting conditions. Rather than processing an entire panoramic image, an image area around a merge line of both cameras involved in the overlapping area are compared. Clearly, if a panoramic image is seamless, there preferably should not be a distinguishable transition area around the merge line. Based on pixel differences between the images of the two cameras wherein one is lighter than the other a color adjustment software is applied. There are different known image processing software methods to achieve that. Furthermore, more than 3 cameras may be used in accordance with an aspect of the present invention to generate panoramic images which are preferably video images.

One aspect of creating panoramic video from multiple cameras is determining the stitch line or merge line between images. This is usually by far the most time-consuming processing need in current panoramic image techniques. The herein and in related disclosures provided method in determining combinable active areas of image sensors for harvesting image data that may be directly combined drastically limits the equivalent stitching time. Once that is achieved one basically has a panoramic video that is created and displayed in real-time in at least 10 image frames per second. To improve further quality of the video there are additional steps possible that remove for instance color mismatch, and image distortion.

The processor speed for image improving corrections has at least three aspects: 1) detecting the distortion; 2) determining parameters to correct distortion and 3) actually performing the correction. In general, steps 1 and 2 require a significant part of processor operation. In fixed and knowns cameras in a determined relative position a processor only has to determine during a calibration what the necessary corrective parameters are. For instance warping or homography to correct an area of distorting are determined during a calibration and may depend on one or more object or scene parameters, as well as known lens parameters, distance of object(s) to camera and other scene and/or camera settings. One may then precompute optimal correction parameters and store them in memory, to be (if so desired automatically) retrieved based on actual recording circumstances. In that case no further processor time or very limited processor time has to be spent on computing settings. This is especially valid for corrected warping for which the parameters will most likely be stable. The same goes for distance dependable parameters. Color correction may take more time, because lighting conditions may be more variable.

A digital video image has a size or frame size related to the lens, a resolution or density of pixels, a color scheme and a frame rate. Clearly a high resolution color video image at 120 fps contains much more data to be processed then a low resolution, gray-scale only 10 fps security camera. Currently used processors in tablet computers and smart phones are powerful enough to perform in real-time a complete 2 images stitching even high resolution gray image. A complete stitching may require less than 5 ms. Pure frame stitching by software may reach between 50-100 ms for average resolution color images. For multiple images, this may not achieve desired frame speeds. However, by using the invention of active areas as provided above. The required number of clock cycles go down substantially. Furthermore, by dealing with fixed active areas of image sensors the processor expensive computation and determination are avoided. Furthermore, because physically no stitching of imaging takes place, only storage of separately generated and processed images, expensive overhead is avoided. In fact, processing parameters may be determined for image data of each separate active sensor area and processed in parallel by separate cores, processors, GPUs or customized FPGAs as for instance offered by Xilinx, Intel and/or others, which provide real-time solutions for 4K resolution image processing.

Accordingly, the herein provided approach of defining active image sensor areas and processing only individually or substantially only individually images generated by active sensor areas. Substantially herein means that some common overhead may still be required. For instance all data must still be demosaiced in order to be displayed on a screen. Demosaicing often includes interpolation with may smooth out some inconsistencies. In that case one may determine an image area around a merge line and at least apply demosaicing to that area, instead of demosaicing only active area data.

In accordance with an aspect of the present invention, a camera system is created by placing multiple cameras fixedly in a single housing, with each camera a relative position to the other cameras that an extended image space with overlap of images is created and wherein active image sensor areas are determined so the combined image formed from the individual cameras form a contiguous panoramic or extended image space camera with a field-of-vision that is greater than that of the individual cameras. There are several steps in accordance with one or more steps of the present invention that facilitates creating a panoramic image that preferably is a real-time panoramic video image. Preferably all cameras in the panoramic camera system are identical or are complementary in their properties. When all cameras are identical it facilitates operations, because all cameras have substantially the same parameters, and thus all or most operations per camera such as scanning and scanlines, pre-warping, distortion correction, blending, lenses, focus mechanism and the like are identical. It may be desirable to operate the cameras with a global shutter mechanism rather than the popular rolling shutter, which may create unwanted artifacts.

With identical cameras hard fixed in a single housing effects that are troublesome in creating a panoramic image from a single moving camera may be avoided. For instance timing differences, parallax effects and other alignment mistakes may be completely avoided.

Other corrective processes may be implemented. For instance during operations or recording of images, a processor test may be performed to check for instance if determination of a merge line and thus of active areas is still correct and allows for correction of merge line parameters. There is a high reliability of manufacturing accuracy. One may reliably assume that during operations merge line deviation is not more than 25 pixels and preferable less than 10 pixels and more preferably less than 5 pixels in any direction. In such a case a test of deviation may be limited to a small search area of not more than the preferred deviation. This dramatically limits processing time. The same approach applied to determination of other parameters, such as parallax, distortion, color matching and that correction will be preferably not be more than 10%, preferably less than 5% and more preferably not more than 1%. Because of the limited overhead, substantially parallel or substantially individually means that not more than 50% of image processing of images generated by active areas of 2 or more individual image sensors in a multi-camera system to create a real-time panoramic video image is by a shared processor or shared processor core. In the alternative one may say that from initial harvesting/recording of image data to displaying the data in real-time panoramic video at least 50% is done on individual active area images. Preferably the individual processing may reach 75% and only at most 25% is dome by shared processing.

The above is also taught in detail in Nonprovisional patent application Ser. No. 17/472,658 filed on Sep. 12, 2021, which is incorporated herein by reference in its entirety. Also incorporated by reference in the current disclosure are all documents and references incorporated by reference that were incorporated by reference in the Ser. No. 17/472,658 application.

In one embodiment of the present invention, one has two or more cameras which are preferably identical cameras, each with a lens and an image sensor. The cameras are positioned preferably in a single housing and also preferably in a fixed position so that images of a scene taken by the individual cameras in combination have overlap. By removing the overlap portions of the images or rather by not harvesting from the image sensor the overlap portions but only the unique parts (also called active part) and make sure that images thus harvested are aligned, one has almost automatically a panoramic or wide Field of View (FoV) multi-camera system. Such a system, by pre-determining the overlap or proper scan-lines during calibration for instance, circumvents the processing expensive part of determining a stitchline as commonly used in generation of panoramic images. Using the pre-determined scanlines that harvest a pre-set panoramic image allows real-time panoramic video. Real-time panoramic video is panoramic video with a frame speed of preferably at least 25 frames per second, more preferably at least 50 frames per second.

Earlier it was described by the inventor how to create such panoramic video images. It requires careful programming of instructions. In a novel approach, steps to create a real time panoramic video from multiple cameras, is enabled by applying neural networks (NNs), deep learning, reinforcement learning (RL) or other artificial intelligence and/or deep learning techniques.

Sensor Mapping via Neural Networks: Instead other and earlier described methods a two or more imaging sensors (e.g., CMOS sensors) are individually calibrated using standardized scene targets positioned in fixed orientations. For instance a neural network is trained to learn the sensor's response behavior, mapping regions of high fidelity, distortion, and variable pixel sensitivity. The result is a sensor-specific “map” defining programmable regions-of-interest (ROIs) optimized for subsequent scanning and image harvesting.

As an illustrative example, a multi-camera configuration (e.g., three cameras arranged in left-center-right orientation) of identical cameras fixed in a single housing are arranged in such a manner that images from these cameras have overlap, for instance in horizontal direction. By harvesting only image data of sensor areas that are not considered overlap, one may harvest and store directly in a video memory for instance, a panoramic or registered image by combining the harvested image. Using AI, one or more NNs are trained to optimize scanline selection based on for instance edge distortion minimization, Feature density distribution in scene content, Learned stitching performance across overlapping margins.

Each camera contains pre-designated margin boundaries (left/right edge masks), which are refined during training to produce optimal seam placement and scan patterns. A scan pattern of an image sensor is the physical reading of the sensor (usually CMOS, but others are possible) elements or pixels. A physical pixel is usually a set of photo-diodes each provided with a color filters, of which the Bayer structure and its required demosaicing is among the most popular. The pixel elements or photo diodes are arranged in 2 dimensional arrays and can be addressed as elements in the array. This is done via instructions performed by the sensor control. The sensor control has a register that contains the boundaries of the scanning and how scans are performed (by row, by columns, consecutive or interleaved etc). The sensor scan control is generally not directly available to general consumer users. Professional interfaces to write instructions to the sensor control are available or may easily be programmed by one experienced in the art of image processing. Tools such as Xilinx Vivado, AMD Vitis, the NVIDIA Jetson platform with VisionWorks or OpenCV, and camera SDKs like Basler pylon or FLIR Spinnaker provide robust environments for programming and controlling camera systems, including fine-grained access to scanline operations and sensor-level image harvesting. One of ordinary skill in camera control programming knows how to program the scanline parameters

In field use, the trained models evaluate the current scene and dynamically compute scan instructions: Selecting ROIs per camera based on scene complexity, lighting, and geometric features; Adjusting scan lines in real time to improve panoramic overlap and visual uniformity; Programming sensor controllers to activate specific pixel blocks based on the generated instructions.

A training system for determining the defined stitchline on active areas of image sensors that are programmed in the sensor controller my have the following components: 1) a Training Unit: it collects and processes calibration images, trains neural models; 2) a Scene Evaluation Engine: Evaluates test and live scene inputs to generate scan instructions to the controller; 3) a Sensor Controller Interface: Communicates scan parameters to sensor hardware; 4) a Composite Stitching Module: Aligns and blends image data using learned seam prioritization. In a further embodiment, one may provide training data associated with setting parameters, such as shutter time, distance to object/focus control, etc. Training data may be a prepared large board with high detail objects such as lines and curves that allow instantaneous check of alignment, including checker boards and the like. This allows for quick alignment check for human supervising and is an excellent ground truth for supervised and labeled neural network learning.

Cameras may be selected that have average or above average edge quality. That is, inside an edge area of about 5% of the image area of a sensor, image distortion is negligible and image details at that limit or inside that limit align perfectly. If one knows the distortion free zone or aa zone where distortion plays no role, one may enforce a ground truth that places the scan-limit inside the distortion free zone. This means that no processing expensive time is required for distortion correction. On the other hand, distortion correction may only be required over a relatively small image data zone. The image correction may be trained in a CNN for instance (also called image calibration) and may be applied when processing time is for instance cheaper than increased quality of a camera. Furthermore, the use of curved image sensors may further reduce image distortion at the edges.

The above enables relatively quick and real-time creation of panoramic video of high quality. The training and execution may be performed on raw image data, and demosaicing, including interpolation and smoothing near the edges creates a high quality transition zone with no or minimal distortion. The trained alignment is independent of later scene content and no processing expensive searching for a stitchline is required. In essence a NN based processor stores in operational mode for each frame a perfect or close to perfect panoramic video image, which may further depend on camera parameter setting such as focus and shuttertime. The other benefit is that while the training may be time consuming, an NN operational mode is fast.

A functional implementation of the above operations may involve the following: A System Setup with: 1) Sensors: Deploy a set of fixed-position CMOS cameras with programmable region-of-interest (ROI) control; 2) A Scene Calibration Target: Place a high-resolution standard scene (checkerboard+grayscale gradient+natural texture panel) for training; 3) Data Acquisition: with Capturing sequences under varied lighting, orientations, and distances and Each image labeled with metadata (sensor ID, position, time, etc.)

A Sensor Mapping Neural Model with 1) A Model Type: A shallow CNN with attention modules or vision transformer (ViT-lite) for identifying spatial fidelity regions; 2) Input Data setting: Calibration images per sensor; 3) Training Target including: Identify areas with distortion, noise, or lower optical efficiency and Output a sensor map highlighting optimal scan zones; and 4) an Output Format: for instance of image data output block sizes which may include confidence levels.

A Multi-Camera Seam Optimization: Architecture example: Three cameras: Left, Center, Right with overlapping fields. The center camera has of course 2 overlap zones. Model Type: Seam optimization via learned stitch evaluator (contrast, texture similarity, alignment score). A Training Dataset: containing high detail panoramic scenes, with stitch line ground truth set manually or via conventional software for supervised targets; and A Model Output: a Per-camera scan window: dynamically adjustable bounding boxes with possibly seam weights used by final stitching module to guide alignment.

An Operational Workflow: 1) Initialization: Load trained maps and seam optimization models into the runtime environment. 2) Scene Evaluation: Low-res preview mode activates across cameras and Model infers scan zones and optimal seam positions. 3) Scan Execution: Each sensor controller activates ROIs accordingly based on the inferred scan lines; 4) Post-processing: Stitch overlapping regions using seam predictor output/Refine final panorama using image fusion methods (multi-band blending, pyramid processing).

Instructions in for instance OpenCV and PyTorch and/or TensorFlow code will enable and perform the embodiments of invention as disclosed herein. Entering the above and following description as a prompt into AI LLMs like Co-pilot, Gemini and ChatGPT will generate executable code and demonstrate that the invention embodiments are enabled, executable and useful.

In accordance with another embodiment a Structured Scene Segmentation for Panoramic Learning is provided. It includes a Training Design with a Scene Creation which includes Constructing a detailed visual scene—hand-drawn, synthetic, or digitally rendered. One further Divides the scene into three adjacent panels (left, center, right) with visually hard boundaries that are imposed as the ground truth. These can be literal lines, distinct color transitions, or masked zones. A Camera Setup Positions three fixed cameras to capture only their assigned segment. Each camera's field of view should strictly contain its assigned part (about one-third) of the scene. This may cover in for instance horizontal Field of View (FoV) of 180 to even 200 or more degrees, which may be called an extended image space. As part of a Labeling each segment is assigned a unique spatial ID and register it to a master scene layout. The neural network receives both the raw image and its “expected capture” boundary as ground truth.

A system's Learning Task has as Training Objective: To scan only within assigned boundaries and how to register individual captures into a contiguous full-scene mosaic. With as Model variants: 1) CNN encoder-decoder for each segment. 2) A fusion module that aligns segments using hard edges as stitching anchors. As Contiguity Assurance Use edge-based blending or pixel matching for verification and Include synthetic distortion (blur, noise) during training to improve robustness in real-world adaptation.

The disclosed approach doesn't just train cameras to be aware of what they're “supposed” to capture—it gives a deterministic training input. It opens doors for: Self-supervised expansion: Let the system infer scene layout from partial captures. Anomaly detection: Recognize when a camera fails to scan its designated region. Scene swapping: Dynamically remap cameras to new segment roles using the same trained fusion model.

Neural Network Architectures that enable the provided embodiments may include: CNN with attention modules (e.g. ResNet+spatial attention) for sensor mapping, is Efficient at capturing local distortions and spatial fidelity. U-Net or SegNet (Semantic segmentation) for ROI Identification to learn pixel-precise regions for optimized scanning. Siamese CNN or Vision Transformer (ViT) for Panoramic fusion as it models inter-camera correlation and alignment. Lightweight encoder-decoder or MobileNet variant for Scanline Instruction as it Generates fast ROI commands per frame in deployment. Multi-task models where a shared backbone (like EfficientNet) supports both segmentation and fusion tasks via separate output heads may be applied. Since structured scenes are used that are divided into fixed segments, the labeling pipeline becomes much easier and semi-automated.

For Sensor Map Training one may provide as Input: Calibration image+scene metadata; as Labels: ROI bounding boxes, pixel confidence scores, known distortion zones. And use synthetic overlays or auto-generated ground-truth masks based on scene geometry. For Panoramic Training: as input Left, Center, Right camera captures. As Labels: Assigned scene segment ID (L/C/R), Stitch boundaries (position, texture similarity metrics) and Final fused image output as supervised target. Labels may be generated programmatically with known scene layout, which drastically reduces manual work.

Human Supervision can assist in making training more efficient. Initial Calibration Scenes are pre-defined with optimal scenes and details. By having an optimal ground truth the system doesn't have to ‘learn” it. Synthetic or Controlled Scenes: Labels are baked in or derived algorithmically. One may even do Live Scene Labeling: Not strictly necessary in this context because inference will use pre-trained models and predict ROIs based on scene features. However, if the system adapts to uncontrolled environments later, one might include a human-in-the-loop validation system—like a GUI that highlights predicted ROI maps or stitchlines for confirmation. Still, most of the core training can be automated.

Among possible variation in imaging conditions are Depth, Focus, and Exposure. Depth of Field Variation may be addressed by having the Model learning focal plane offset per camera via calibration scenes shot at varied depths. It may Include blur detection modules (e.g., Laplacian-based or learned focus map) to guide stitching regions that are sharp and overlap properly. Shutter Speed Differences may be addressed by Normalizing exposure during preprocessing using histogram equalization or learned illumination correction. Training the fusion module to detect ghosting or parallax artifacts that arise from timing mismatch and compensate via frame warping. Light Condition Shifts may be addressed by Using HDR-style input augmentation—training with overexposed and underexposed frames to build robustness. One may also Implement a pre-fusion brightness homogenizer across frames.

Training Enhancements in order to build robustness may be Data Augmentation such as Injecting synthetic exposure noise, defocus, and lighting gradients into training inputs to simulate real-world conditions. Multi-View Supervision For fusion models, include cross-camera feature consistency loss during training. Adaptive Stitch Zone Selector by Deploying a module that chooses stitching zones not just based on margin location but based on local clarity, brightness, and texture continuity.

One may then Incorporate Settings and Detectors into Neural Network Training with the following as potential Variables. Camera Intrinsics such as Focal length, aperture (f-stop), shutter speed, ISO, These influence depth of field, motion blur, and exposure-critical to scan quality. Environmental Detectors such as Ambient light levels (from onboard sensors or image histograms). Temperature (can affect sensor noise or mechanical response). Scene depth proxies (e.g. stereo disparity if available). And even Scene Complexity Indicators such as Texture richness, edge density, contrast maps.

One may apply Focal depth range as an input feature as it helps the system to infer sharp vs soft regions for ROI selection. Shutter/ISO as input feature guides exposure normalization layer. Brightness level as a label validates fusion quality under varied conditions. A depth map as a supervised label assists in aligning seams across focal planes, This may serve as a scene condition classifier, which acts like a gating signal to scanline-instruction generator.

A Training Architecture Suggestion may include as input an Image patch, Camera settings vector [ISO, shutter, focus, etc.]. Scene signal vector [light level, sharpness, etc.] The model includes a Shared encoder for image, Settings passed through an MLP (multilayer perceptron). Combined embeddings are used to predict ROI scan zones, Seam alignment zones and Correction factors for fusion. One then includes a Loss Function for Scene alignment loss, Exposure consistency loss and ROI coverage vs ground truth. This provides a full context-aware vision system-learning not just where to scan, but why.

Defining a Loss Function may be a next step to establish training intent-what the model is designed to improve. It clarifies measurable targets like scanline accuracy, alignment quality, exposure consistency. In this case loss functions can represent: Image fidelity in sensor regions, Stitchline placement precision, Seam blending consistency and Lighting and focus continuity, for instance. The loss functions may include scanline overlap loss, which Penalizes misaligned stitching seams relative to ground truth or geometric boundary; Region Confidence Loss which Encourages selection of high-fidelity scan zones; Photometric Consistency Loss to Reduce color/exposure differences between stitched segments; focus quality loss to ensure sharper zones for stitchline positioning; and Distortion Penalty Loss which Discourages placing seams in distorted regions based on learned distortion maps. These can be combined using weighted coefficients in a composite objective function, which becomes a model's backbone for training. An example may be: total_loss=(w1*scanline_alignment_loss+w2*photometric_consistency_loss+w3*region_confidence_loss+w4*distortion_penalty_loss). One may decide the weights (w1-w4) depending on which goal is most critical (e.g., seam accuracy vs exposure blending). The training process utilizes a composite loss function comprising seam alignment error, photometric deviation across stitched regions, and scan zone confidence scoring. These metrics guide the neural network toward optimal sensor-specific region harvesting and panoramic image fusion.

The image stitching system employs a sensor-aware neural architecture trained via region-aligned composite loss. Input images are preprocessed to standardize exposure and crop alignment before passing through region selectors. Seam placement is optimized using photometric consistency and geometric distortion maps. Performance is evaluated using SSIM, manual inspection, and heatmap-based prediction confidence.

One may provide a Data Specification describing the input data structure clearly: image resolution, sensor layout, color channels, metadata requirements. Include examples of edge cases like partial sensor dropout or extreme lighting. Architecture Sketch A high-level overview of the model architecture (e.g. encoder-decoder, U-Net variant, transformer module) helps others orient quickly. You don't need full implementation-just the key blocks and flow. Training Pipeline Details Include how samples are fed in: batching strategy, augmentation, cropping. Mention any domain-specific tweaks like rotational alignment or exposure correction before feeding images. Evaluation Protocol Give specifics on how performance is measured. Examples: PSNR/SSIM comparisons, Manual seam inspection scores, Confidence heatmaps across stitched regions, Outlier detection on stitchline displacement

Implementation embodiments may include libraries in PyTorch, OpenCV, TorchVision) and any custom layers or modules being built. Simple structures like RegionSelector or StitchPredictor enable shortcuts.

An intermediary step may be included to make an optimal stitched image using classical stitching technique and cutting the optimal image in 3 parts with a part corresponding directly to one of the 3 cameras in the illustrative example and use these as ground truths. This provides a bootstrap method: use classical stitching tools to produce a high-quality panoramic image, then segment it into camera-sized slices to serve as ground truth targets for supervised training. This allows your neural network to learn: How optimal seams behave; What high-fidelity stitched output looks like; and How each camera's contribution aligns spatially and photometrically. The steps may be described as: 1) Capture Scene with Three Cameras and use fixed layout: Left, Center, Right and Capture scene with clean overlaps (˜10% margin for instance); 2) Stitch Using Classical Techniques by Using OpenCV, Hugin, or commercial stitching software and Apply distortion correction, seam optimization, exposure matching; 3) Segment Stitched Image into Ground Truth and Crop output into three distinct panels: Region L for Left Camera, Region C for Center Camera and Region R for Right Camera and Align segments precisely with each camera's expected capture zone; 4) Use These as Supervised Targets: Each cropped segment becomes the label for a) Sensor map training (e.g. expected ROI); b) Seam predictor training (what zone to retain) and c) Fusion model supervision (what final result should look like). The system has thus perfect targets derived from proven techniques. It reduces the need for manual annotation-because seam placement is implicit in the stitched output. And control is gained over error sources. Any mismatch between predicted and stitched zones highlights where NN refinement is needed.

In a further embodiment the neural network (NN) is programmed to learn distortion correction as part of the training process and adds another layer of intelligence to the pipeline. It is effectively teaching the network to self-calibrate against edge distortions by comparing imperfect inputs with geometrically corrected ground truth.

Embedding Distortion Correction into Learning may include: construct a Setup with as Input: Raw edge-distorted images from each camera. Use as Ground Truth: Cropped panels from the classical stitched panorama (which inherently corrects distortion). As Training Strategy Use a loss function that penalizes geometric inconsistency, especially near the borders. Examples are: perceptual loss, SSIM loss, or customized distortion-aware loss. Introduce spatial transformers or lens models inside the network and Learn to warp or undistort the edges dynamically. Apply unsupervised fine-tuning using self-consistency between predicted and reference seams. In addition one may Add a synthetic distortion dataset: warp known good images with barrel/pincushion functions and challenge the model to restore them. This bootstraps correction even when real distortions are subtle or noisy. This correction may matter as Optical distortion is a nasty confounder for seam estimation and photometric alignment. By learning to correct it, the network gets better at stitching, fusing, and even predicting sensor boundaries. It brings robustness across different camera models and scene types, with less dependence on perfect input or manual calibration. It provides a modular vision pipeline that mirrors human intuition: first see clearly (undistort), then align intelligently (stitch), and finally learn what good looks like (ground truth).

As a Model Block a Distortion Correction Module may have an Input Stage that accepts Raw image from edge camera (e.g., Left or Right) as well as Optional: camera metadata (focal length, sensor geometry). It also may have a Distortion Estimation Network with a Convolutional backbone (e.g., ResNet or Swin Transformer) and that provides as an Output: parameter map for distortion type & magnitude. It may Use radial distortion functions like: Barrel: r′=r (1+k1r2+k2r4+ . . . )r′=r(1+k_1r\hat{ }2+k_2r\hat{ }4+ . . . ). And also Pincushion: inverse of barrel, like negative kik_i. Also included may be a Spatial Transformer Layer that Learns pixel-wise geometric warping, Applies estimated distortion correction and Outputs an undistorted image. The Loss Functions may have as components Photometric Loss that Enforces similarity to ground truth panel (MSE or SSIM); Geometric Consistency that penalizes residual warping near edges for instance and feature alignment that enforces matching of references in high level features (via VGG for instance). The model may Start with synthetic distortion-teach a model to reverse it before applying real scenes. It may Use multi-scale loss: edge distortion is more noticeable at high res. One may try contrastive learning: same scene with/without distortion paired together.

This block can either be standalone (pre-correct before fusion) or baked into a larger pipeline where stitching, seam prediction, and distortion handling happen jointly. It may use radial warp functions on stock images to kickstart things.

An additional layer may be how the refined image data is laid out in video memory. It can make a difference in read/write performance, especially when dealing with real-time stitching or rendering pipelines. Especially one may consider Scanline Row vs. Column Storage. Scanline (Row Major) is native to most GPUs and may be preferred for rasterization. It is commonly used in standard rendering and horizontal stitching. Another embodiment applies Column Major (storing column wise) which may be Better for vertical seam analysis or sensor mapping for instance in certain multi-cameras layouts. If a stitching pipeline favors horizontal alignment (like panoramic sweeps), scanlines are typically more efficient. But if distortion or seam prediction works better vertically, column access might simplify memory reads. One may also consider a Tiled or Chunked Layout. Divide image into tiles (e.g. 64×64 or 128×128 blocks) and Store tiles contiguously in memory. It Facilitates parallel processing, especially on GPU with compute shaders. This enables Preloading tiles to texture cache, Running seam predictors only on relevant zones and Applying distortion correction locally.

One may also apply Channel Packing: Depending on a pipeline, one might encode extra data in unused channels: Use RGBA where R,G,B: actual color data A: seam confidence, distortion coefficient, or fusion weight. Alternatively, store multi-pass outputs (e.g., raw image+corrected+final) in separate textures for fast GPU switching. Furthermore Memory-Aligned Buffers may be applied for Aligning scanlines to 32- or 64-byte boundaries, Padding if necessary to avoid cache misses, and Using direct memory access (DMA) if dealing with hardware stitching. A Real-Time Bonus Concept is Buffer Ping-Pong by Setting up two buffers: One for reading and One for writing intermediate output. Then swap roles every frame or iteration. It's classic double-buffering to avoid stalls during distortion correction+seam blending.

Because one is dealing with large amounts of data Parallel Block Processing with Smart Memory Layout may be beneficial. This may include using multi-core processors. Making every core earn its keep by a Tiled Image Layout that Divides the image into uniform tiles (e.g. 64×64 or 128×128 pixels), and Stores tiles contiguously or in a Morton (Z-order) layout for spatial locality. This boosts cache efficiency and minimizes memory latency when cores access adjacent data. This enables a Tile-to-Core Assignment wherein Each processor core (thread block on GPU, logical core on CPU) gets: One tile or a group of neighboring tiles, Local copy of metadata (distortion parameters, seam maps), and No cross-tile dependency=maximum parallelism. This creates a Pipeline Within Each Core to Perform distortion correction, Seam prediction, Fusion weighting, and Write processed tile to output buffer. Thus Each core runs the full local pipeline, which scales across GPUs (via compute shaders or CUDA kernels) and Multi-threaded CPUs (via SIMD or OpenMP). In a further embodiment on may apply Double Buffer+Sync Barrier. It Uses two buffers: one for reading, one for writing. It Inserts sync barrier to avoid race conditions. If using GPU: shared memory per thread block can store intermediate maps for faster seam stitching. As a Bonus: Adaptive Block Scheduling by Adding intelligence to the scheduler: Prioritize tiles near high-gradient zones or seams and Dynamically assign more compute to distortion-heavy regions. This provides load balancing across cores and avoids bottlenecks on “hard” tiles.

It is believed that an embodiment that performs reading an image column wise may be novel for panoramic images. For panoramic imagery, where horizontal continuity dominates, column-wise reading may unlock new efficiencies in both processing and memory layout. Traditional Stitching Assumes Scanline (row-major) access, Seam searching and blending along horizontal overlaps and Linear rasterization for display output. However, in panoramic contexts, especially with multi-sensor setups: Seams often run vertically and Distortion near left/right edges needs tight vertical alignment. Seam and fusion quality depends heavily on vertical gradients. This means column-wise access could better reflect Seam confidence along image height, Distortion warping patterns and Vertical photometric transitions. Column-Wise Storage Enables Improved Block Parallelism that Assigns vertical column strips to cores and Each core corrects distortion and blends seams vertically. It Works very well for real-time sensor stitching. Smart Compression as Vertical columns can be more compressible in static scenes and one can apply predictive compression or run-length encoding column-wise. As to Seam Map Integration one may Store column confidence maps alongside pixel data and Use extra channels to cache blending weights or geometric coefficients. One may also apply A Hybrid Format. It stores data in a transpose-friendly format, allowing both row and column access: Preprocess into cache-aligned tile blocks; Each tile can be reoriented dynamically for seam prediction or distortion handling; SIMD-friendly for CPUs, warp-optimized for GPUs.

In the context of system requirements one has to determine Neural Network Types for Real-Time Optimization of extended image space creation. For the distortion-aware, scanline-centric, stitching pipeline, some suitable neural models are: Convolutional Neural Networks (CNNs). Purpose: Feature extraction, distortion correction, seam analysis with as options ResNet-18/34: Lightweight and fast, MobileNet: for mobile and edge inference; and EfficientNet-Lite: Balanced accuracy vs speed. Attention-Based Networks for Learn long-range spatial relationships (especially for seams and fusion zones) with as example options Swin Transformer-Tiny: Efficient and patch-based and MobileViT: Transformer logic optimized for edge devices. Spatial Transformer Networks (STNs) for Learning geometric transformations for distortion correction and may be inserted as modules within other CNNs. U-Net Variants for Pixel-level seam prediction or ROI maps, for encoding complex spatial transitions without heavy compute.

Hardware Choices: Real-Time+Edge Efficiency and what to consider for the processors that power a system as provided herein. Edge SoCs for embedded panoramic systems for instance NVIDIA Jetson, Coral Edge TPU, Mobile GPUs in smartphones and portable devices such as Apple Neural Engine, Adreno, FPGA/ASICs for Custom, ultra-low latency workflows such as Intel Movidius, Xilinx Zynq. For prototype development one may apply ultra-fast desktop hardware such as RTX 3050-4080, AMD RDNA. A system like Jetson Orin Nano or Xavier NX would be a powerhouse for deploying tiled scanline neural models with real-time throughput.

An Edge Deployment Strategy may include Quantization: Convert models to 8-bit or lower precision (via TensorRT or ONNX) to shrink memory and boost inference speed. Tiled Inference: Feed blocks or scan columns into models in parallel threads. Asynchronous Buffering: Use double or triple buffering for image regions to avoid compute delays. Multi-core Scheduling: Assign preprocessing, inference, and post-stitching tasks to dedicated threads or hardware cores.

The above is an illustrative example of applying hardware that is currently available. While initially some edge computing may be required for high performance on larger datasets like 4K imaging devices, it is believed that further development will provide extremely high processing throughput processors including for neural or tensor processing that will enable in-device autonomous processing without the need for additional edge computing. The above therefore is for illustrative purposes only and not limited to any specific processor or processor architecture.

In a further embodiment of the present invention Reinforcement Learning (RL) is applied. It may be applied in for instance in the image alignment step. It combines the precision of supervised learning with the dynamic adaptability of reinforcement learning for stitchline prediction. Structuring a supervised reinforcement learning (RL) pipeline to optimize stitchlines intelligently may include: 1) Define the Environment: with as Input: Overlapping image tiles or scanlines and as Output: Seam/stitchline coordinates or pixel-level masks. Reward Signals are: Based on metrics like alignment accuracy, distortion minimization, edge continuity, or perceptual loss; with as Constraints: Geometric consistency, optical flow smoothness, stitching artifacts. 2) Initial Supervised Training. Train a model (e.g., CNN or U-Net) to predict stitchlines using annotated data with as Loss Function: Use pixel-level cross entropy or IOU loss for binary seam maps and as Dataset: Curated samples with known good seams. The Goal: Establish a baseline that “knows how to stitch correctly.” 3) Simulated Environment Setup by Creating synthetic or semi-synthetic environments where Stitchline predictions can be applied and Feedback can be evaluated (alignment score, edge blending quality, etc.). One may simulate camera motion, lighting changes, scene diversity. 4) Design the RL Component by State: Image patch features, previous stitchline action, distortion map; Action: Predict next seam path or adjust previous; Reward: Based on visual quality, consistency metrics, or human rankings; and Use policy gradient methods like PPO or A2C, optionally combined with value networks for stability. 5) Supervised RL Fusion. Use supervised pretraining as the initial policy and continue training with RL to refine: Applying Reward-Weighted Regression or RLHF-style fine-tuning, Reinforcing the policy toward maximizing seam quality under real-world distortions, and Introducing random perturbations to help generalize. 6) Validation & Benchmarking by Testing against: Known datasets with ground truth seams, User-ranked seam quality, and Robustness under occlusion or lighting shifts.

One may align an RL model with human-perceptual quality by applying a Structural similarity index (SSIM) of stitched output, defining Seam deviation from ideal (low curvature, edge preservation), Blending quality score (visual discontinuities), and Human feedback on stitch realism. This hybrid pipeline lets one build a stitchline predictor that isn't just accurate—but adaptable and intelligent. It learns rules, refines with experience, and tests in dynamic environments.

RL-Driven Stitchline Optimization: Enablement Highlights. Environment Definition Inputs: Overlapping image tiles or scanlines; Outputs: Seam coordinates or pixel-level seam masks; Reward signals: Alignment accuracy, Distortion minimization, Edge continuity, Perceptual loss; Constraints: Geometric consistency, Optical flow smoothness and Artifact suppression. This defines the RL task space and makes it reproducible for practitioners. In Supervised Pretraining Use CNN or U-Net to predict seam maps from annotated data with Loss functions: Pixel-level cross entropy and Intersection-over-Union (IoU). Use as Dataset: Curated samples with known optimal seams. This establishes a baseline policy that RL can refine and allows bootstrapping.

RL Component Design includes 1) State: Image patch features, prior seam actions, distortion maps; 2) Action: Predict next seam path or adjust previous seam; 3) Reward: Based on SSIM, edge continuity, blending quality, or human feedback. One may use PPO, and/or A2C and optionally with value networks for policy stability. This structure is highly teachable and aligns with modern RL frameworks.

One then performs Supervised+RL Fusion by Starting with supervised weights, and Applying Reward-Weighted Regression or RLHF-style fine-tuning. One may Introduce random perturbations to improve generalization. This hybrid approach balances precision and adaptability and enables real-world deployment. Validation & Benchmarking may include Testing against Ground truth seam datasets, User-ranked seam realism and Robustness under occlusion, lighting shifts. With as potential Metrics: SSIM for perceptual similarity2, Seam deviation from ideal (low curvature, edge preservation), Blending quality score for visual continuity and Human feedback for realism and acceptability. These metrics are believed to well-established and reproducible, which supports enablement and performance claims.

In one embodiment one considers, processes and trains NNs only on a strip of image data around overlap areas. The consideration is that outside these strips there is no or almost no distortion and efforts to process these areas would be pretty much moot. For instance, one may consider and process a strip of for instance 10-20 pixels wide for alignment and distortion correction. Narrowing down to minimal-width scanline regions, like 10-pixel or up to 20 pixel strips, transforms what could be a high-bandwidth stitching challenge into a more lightweight, focused prediction task. It offers Data Efficiency: One drastically reduces the input dimensionality, enabling faster inference and lower memory usage. Create Focus on Overlap: The seam lives in the overlap zone, so analyzing just those adjacent strips is enough to optimize alignment. Local Optimization: The RL agent can predict adjustments or stitch decisions based only on localized features-which enables parallel processing across strip pairs. There is also an RL Advantage in This Setup. With narrow regions, your RL agent doesn't need to explore the entire frame. It now Takes simple actions (shift seam, adjust blend), it Gets frequent reward signals for alignment quality and it Can use faster policy rollouts across tiled regions, even in real time.

One may define the state space as: Left-strip edge map, Right-strip edge map, Prior seam deviation and Estimated distortion gradient. Then keep your action space minimal: seam shift, width tweak, blend method choice, etc. A Practical Illustrative Implementation may be: 1) Supervised Pretraining: Teach a CNN to analyze pairwise 10-pixel strips with labeled seams; 2) RL Agent Overlay: Introduce a lightweight policy network that tweaks seams based on feedback 3) Reward Engineering: Seam clarity (via edge continuity), Stitchline curvature penalty and Blending artifacts score. The approach respects the constraints of real-time edge deployment and opens the door to intelligent seam handling. It's lean, and scalable.

RL agent overlay introduces a lightweight policy network that tweaks seams based on feedback, means the following. One already has a supervised model that predicts stitchlines based on image data. Now one desires to add a second layer of intelligence—an agent that observes how well those stitchlines perform and learns to improve them over time. This is how that may work in detail. A base model that is supervised is trained on labeled seam data. It predicts an initial stitchline between two image strips and is fast and deterministic. The overlay is an RL Agents that takes the base model's output as a starting point. It evaluates the seam quality using a reward function (e.g. edge continuity, distortion metrics). And it Learns to tweak the seam: shift it, curve it, change blending parameters. An example workflow of a base model for instance predicts a seam between two 10-pixel-wide strips. The RL agent then observes and gets the seam, edge maps, and distortion gradients. It acts and nudges the seam left/right, adjusts blending, or flags it for reprocessing. It receives reward: based on how well the final stitched output looks (e.g. SSIM score, human rating). And updates policy and learns which tweaks improve quality across different scenes. The overlay doesn't replace the base model—it's like a smart editor that learns from experience.

In a further embodiment, using reinforcement learning to automate re-calibration of active image sensor areas via a standardized calibration board (like a wide-screen TV) takes the system from passive to self-correcting. Embodiment: calibration as a reinforcement task. Traditional calibration involves manually marking or validating active sensor areas, especially in multi-camera systems. These regions tend to drift due to heat, wear, vibration, or lighting changes. A novel embodiments reframes this as an RL agent actively monitoring stitching/seam quality over time. After several usage cycles, it may detect drift or degradation. Agent triggers a re-calibration loop using known reference imagery (TV screen pattern, checkerboard, etc.). Reinforcement learning is ideal for this because: Reward signal is naturally defined: High alignment quality, low edge discontinuity, minimal ghosting. State evolves over time: The seam prediction degrades slightly per session; environment changes. The agent learns adaptation strategy: Retrain or re-tweak active image regions to restore optimal performance. A policy may dictate: If alignment score drops below threshold and calibration board detected, initiate recalibration loop and learn improved parameters. Over time, the RL agent gets better at knowing when and how to recalibrate—not just reacting, but preemptively adjusting.

A Workflow, as a self-calibrating pipeline with RL may include: baseline calibration (supervised) where the system is trained to stitch using default active sensor areas; calibration board detection wherein a TV panel emits known calibration pattern (could even be dynamic); state Input for RL Agent includes current seam deviation, past alignment scores, and detected calibration pattern. Actions agent can take include adjust crop boundaries for sensor regions, remap distortion parameters and tune blending profiles. With reward function: improvement in seam quality, restoration of pre-drift metrics and speed and stability of calibration; and memory/tracking with session history used to detect performance decay and calibration timing optimized over repeated uses.

Smart usage tracking. one may embed a counter or usage heuristic—say, every 100 seams stitched, trigger a passive calibration sweep. if calibration board is in view, re-learn active areas. if not, log it and wait. That creates intelligent maintenance, powered by learning, not by fixed schedules.

One of ordinary skill in image processing and AI programming is able to translate the provided architecture into PyTorch with data modules such as strip extraction: convert raw images into paired narrow scanline segments (e.g. 10-pixel-wide vertical bands); calibration board detection: use simple CV filters or pre-trained models to recognize TV calibration patterns; supervised backbone including a model such as a lightweight CNN or U-Net for seam prediction; training: using a model, a criterion and an optimizer; as dataset: custom dataset class handling paired strips and seam masks; RL overlay module with agent: PPO or A2C-based policy network, environment: custom gym. Env class with actions like seam tweak, crop adjust, blend tweak, and rewards: defined by visual alignment metrics (e.g., edge continuity, perceptual loss). An example RL action cycle: for instance may include 1) action=agent.select_action (state), 2) next_state, reward, done=env.step (action); 3) agent.learn (state, action, reward, next_state, done). A calibration feedback loop includes a loop triggered based on usage count or performance decay, an RL agent that watches for the calibration board and initiates re-tuning; and a refining of crop boundaries or seam predictors using new feedback. The above architecture is modular, interpretable, and scalable. For instance, PyTorch's ecosystem (e.g., TorchVision, Stable-Baselines3, Optuna) makes each piece doable and implementable-supervised seam prediction, policy learning, environmental simulation, and dynamic recalibration.

FIG. 10 provides a schematic of high-level structure with its logical breakdown. It provides a framework that enables: a supervised model that sees the seams, an RL agent that adjusts them, a calibration board or usage trigger that starts retraining cycles. One may then plug-in: transfer learning modules, real-time data augmentations, and visualization dashboards for seam quality drift. The system provides a transformation of a previously mainly manual, static calibration process into a dynamic, learned system that adapts, optimizes, and executes with speed and precision. Manual “active area” creation→Learned scanline mapping. The system learns the optimal regions to scan and stitch. Time-consuming training→Real-time execution The heavy lifting happens during training. Once deployed, the model runs fast-especially with parallel cores and optimized memory layout. Distortion correction→Seam-aware refinement Even complex corrections can be handled in real time with tiled processing and GPU acceleration. It includes Calibration→Self-correcting intelligence The system knows when it's drifting and recalibrates using reinforcement learning and known patterns. It enables scalable deployment: across devices, cameras, and environments, robust performance: even under changing lighting, focus, or sensor drift and future-device design: including use of edge processors, neural cores, and adaptive pipelines.

The above creates an extended image space, in fact a real-time video extended image space, that with at least 3 cameras may cover a horizontal field of view (FoV) of 180-200 degrees or even greater. The extended image space as discussed earlier will be calibrated and matched to real space. This means that a position in real-space, for instance based on a viewing direction corresponds to a position in extended image space, and a position in extended image space corresponds to a viewing direction in real space. This will be applied next to create a virtual gimbal—or an e-gimbal—that operates entirely in software, leveraging the extended image space to track and stabilize objects without any or very few mechanical movement devices.

In a further embodiment, the extended image space, which may be created by a multi-camera system, is applied to create an electronic tracking system which is called an e-gimbal. In the following neural networks and more general machine learning such as Reinforcement Learning (RL) and other supervised and unsupervised machine learning will be applied to train a vision system and apply the trained system operationally. An underlying idea there to, is that deterministic programming as disclosed earlier, may require individual programming due to small but still significant variations in system components and overall integration. The system training approach allows a trained system to select or rather construct an optimal solution based on its training data. This allows a more flexible and high quality implementation. A potential downside is a complexity and time consuming training requirement. The training may happen in a laboratory or manufacturing setting, where time is not a limitation. One may use weeks or even months to create a best training. Once well trained, the operational system is very fast and operates real-time and can be replicated in unlimited numbers on basically identical systems.

In one embodiment neural anchoring with inertial guidance is provided. Core concepts include a static object or a point on the horizon being video recorded with a moving camera: The object or pre-determined point stays put, but the camera (held by a user) moves unpredictably. One establishes Initial lock-on: Use inertial sensors (such as IMU: accelerometer+gyroscope and also compass and if required a location system like high res GPS) to estimate the camera's orientation and lock onto the object or location. This may be by having for instance having an initial window in a camera viewer, for instance centered in a field of view of a multi-camera system with an extended image space. Such a space my cover up to 180 degrees of vison field or even greater, for instance 200 degrees or greater. Greater fields of vision may be realized with for instance more cameras. This requires that the cameras have to be positioned in such a manner that they extend beyond the flat surface of for instance a smartphone. This can be created for instance with a circle shaped construction that holds the cameras and that covers a greater than 180 degrees field of vision. The large (for instance 180 degrees) FoV assures for most applications that an object that is recorded most likely remains within the FoV of a camera. Even when the object seems to leave the FoV, under most circumstances a user can adjust the pointing direction so the object remains with the FoV of the multi-camera system. In one embodiment a user points a multi-camera system at an object and sets, for instance by instruction, such as voice or pushing a button or activating an instruction, an initial capturing position of the camera system. At that time of activation, inertial sensor data and/or positioning data such as GPS data, altitude and compass data are stored and associated with the initial window. That is: an initial window position in extended image space is associated with a real-life pointing to an object. One may calculate the actual GPS position of an object by triangulation by moving the camera system to another position and point again centered with a window at the object. By using the two for instance GPS positions of the camera, a GPS position of the object is of course at an intersection of the two different pointing directions, which may be computed rapidly by a processor on the camera.

An IMU unit is an Inertial measurement unit, which is well documented. With an IMU one may determine at least camera rotation accurately. One may also use it to estimate by dead-reckoning at least to determine distance change. There are ways to determine actual position of a smartphones and thus of objects that are available and may be more widely affordable in the near future. They at least right now enable one of ordinary skill to fairly accurately determine a position of an object within centimeters rather than meters as in GPS. One is Real-Time Kinematic (RTK) GPS, GPS III satellites, Ultra Wide Band and other global navigation satellite systems (GNSS) like Galileo. Accordingly, one is enabled to determine an accurate pointing direction of a cameras as well as estimating reliably a distance to an object.

Devices known as GPS tracking tags or GPS trackers exist that transmit a fairly exact location including a height. These devices are widely available and used for a variety of purposes, including tracking of objects. It works by receiving signals from multiple satellites in the Global Positioning System (GPS) network. Using a process called trilateration, the device calculates its precise geographical coordinates (latitude, longitude, and elevation). The device in accordance with an aspect of the present invention transmits this location data to a multi-cameras system as disclosed herein. This may include Cellular Networks: Satellite Networks; and/or Bluetooth or similar wireless technology. In accordance with an aspect of the present invention, a cameras system as disclosed herein which may be moving receives positional data of a device carrying or attached to an object that may be moving. Well known spatial geometry may be applied by a processor in or supporting the cameras system to determine a position of the object and a bounding box or window in the extended image space of the camera system. Such determination relies on an earlier calibration of the extended image space related to physical space. Such calibration may be algorithmic or trained to a neural network such as a CNN as disclosed herein using data. This may be enabled by using data from an IMU on the camera system. In one embodiment a positional tag may be a smart phone that transmits its position. Such a system thus does not strictly rely on tracking and detection applications like KCF and/or YOLO, but has immediate object bounding boxes. This may be beneficial when many objects or in a FoV and need for instance to be avoided. The camera system may be programmed to have different zones, like a zone of interest, a zone of alert and a zone of action. Objects in a zone of interest may be tracked but not displayed, objects in a zone of alert may be displayed for instance in non-alarming colors or grey scale and objects in a zone of action are displayed in full color and may cause further processing by the system.

The system performs the following steps: Real-time tracking: As the user (and/or the camera system) moves, IMU data updates the camera's pose, and the system calculates where the object should appear in the extended image space. In addition Neural refinement: A neural network refines the object's position, compensating for drift, occlusion, or sensor noise. Thus, an IMU sensor combines accelerometer and gyroscope data to estimate a camera pose. The system may also determine or estimate a position of the camera. The system then determines a window in extended image space reflecting the place of the object in the extended image space. In cases where the change in distance between camera and object is relatively small like less than 5% for instance, or preferably less than 1%, knowing the rotation of the camera may be sufficient to compute accurately where a window in extended image space should capture image data. However if one significantly diminishes or increases the distance to an object, the change in distance should be included in the processor computation. Real-time knowledge of position coordinates makes this an easy

The system is trained to translate real-world pointing direction (from IMU+GPS+compass) into a precise location in the extended image space. It includes the following steps: Train a neural network to learn the mapping between: Real-world orientation and position data (IMU, GPS, compass) and pixel coordinates in the extended image space. This allows the system to generalize across different hardware setups and environmental conditions. Neural networks are more effective when approximating high-dimensional functions rather than directly mapping high-dimensional spaces. This supports using a learned function to translate sensor data into image-space coordinates.

Distance correction loop for window adjustment to adjust the angle and window location in extended image space based on changes in distance between camera and object. Monitor distance changes using: for instance dead reckoning from IMU; and/or RTK GPS or UWB or other accurate at least decimeter precision positioning for precise position updates. When distance changes significantly (e.g., >1%), recalculate the angular displacement to the object and Update the window location in extended image space accordingly. systems like Kinovea and KEYENCE vision platforms emphasize the importance of angle correction based on rotation center and distance calibration. These principles apply directly to the correction loop

Real-time tracking workflow includes Initial lock as a user points and activates tracking; Capture IMU+GPS+orientation data and associate with object in image space; pose estimation and IMU updates camera orientation in real time; mapping via NN as the neural network translates pose to image-space window location; distance correction where the system adjusts angle and window location based on change in object distance; neural refinement NN corrects for drift, occlusion, and sensor noise; triangulation for multiple pointing positions used to estimate object location. The system then ‘knows’ the location of the static object in image space and captures the data within a pre-sized window determined by the computed location. Use supervised learning with labeled data: each training sample includes sensor data and corresponding object location in image space.

An embodiment for training a neural network to calibrate the extended image space to learn the mapping between sensor data (IMU, GPS, compass, camera pose), visual input (images from 3 cameras), and object location in extended image space (pixel coordinates or window region) is illustrated next. One may use a sizeable board with distinct markers: LEDs that may be activated, printed fiducials (e.g., ArUco, AprilTags), or high-contrast objects. The board as it is called may be a video screen of at least 3 by 3 meter, or at least 5 by 5 meter. Each marker has a known position in physical space. Optionally label each marker with a unique ID and coordinate. In a multi-camera system capture synchronized images from all cameras (3 in this example, but there may be multiple rows of cameras). Ensure overlapping fields of view to build the extended image space. Record corresponding sensor data (IMU, GPS, compass) at each capture. Each training sample includes: as input: IMU orientation (quaternion or Euler angles for instance), GPS position, compass heading and camera pose (if available). It provides as output: pixel coordinates of each marker in the extended image space, and optionally: object ID or label.

A corresponding neural network architecture may include CNN+MLP For direct image-to-coordinate mapping; a Vision Transformer for spatial reasoning across multiple views; a Siamese or Triplet Network for matching objects across camera views; and an Encoder-Decoder for heatmap prediction or segmentation.

A neural calibration training pipeline for extended image space may include: 1. Calibration data collection with setup: Place a calibration board or screen with distinct markers (LEDs, fiducials, or printed targets) and ensure visibility across all 3 cameras. Captured data per frame include: images from camera A, B, and C (synchronized), IMU data: orientation (quaternion or Euler angles), position data, compass heading, known marker positions (physical coordinates or IDs). 2. Preprocessing, including: stitch or align images of individual cameras captured by the window into extended image space (optional if NN learns across raw views); detect markers in each image (using OpenCV, ArUco, etc.); label each marker with its pixel coordinates in the extended image space; normalize sensor data (e.g., scale GPS, convert orientation to consistent format). With output: training samples with: Input: sensor data+camera images and output: labeled pixel coordinates of each marker. 3. neural network training with model input: sensor data (IMU, GPS, compass) and Optionally: raw or processed camera images. model output: Pixel coordinates of each marker in extended image space and optionally: heatmaps or bounding boxes. A training strategy may include supervised learning with labeled data, Loss function: Mean Squared Error (MSE) for coordinate regression or cross-entropy for classification, and Augment data with rotations, lighting changes, and occlusions. 4. Validation & Refinement with validation: use a separate set of marker positions and poses and measure pixel error between predicted and actual marker locations. Refinement: Add more diverse poses and distances and Fine-tune with real-world scenes (not just calibration board)

Optional enhancements may include multi-task learning: predict object ID+location jointly; temporal modeling: use LSTM or Transformer to learn across time; uncertainty modeling: output confidence scores for each prediction; and self-supervised pre-training: learn spatial features before fine-tuning on labeled data.

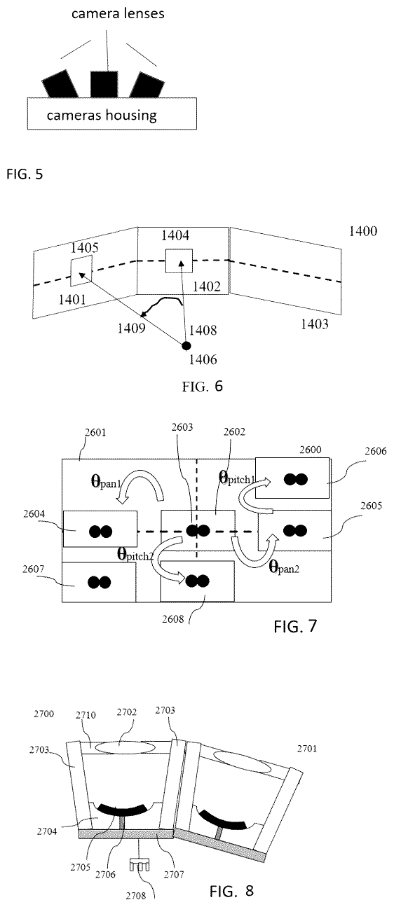

Once the coordinates of the new window in extended image space are determined, there are several ways to display only the window image data. One way is to display only data in a video image memory that contains the whole extended image space, only the image data within the window coordinates which may be mapped to addresses in the video memory. Yes another embodiment applies real-time updates of the individual scan-line control of the individual image sensors of the cameras. This is illustrated in FIG. 3, FIG. 4 and FIG. 5. FIG. 4 shows in diagram a camera system in accordance with an aspect of the present invention. herein 6 cameras which are preferably identical cameras and preferably with curved image sensors, are placed and fixedly held in a camera housing. In this particular example there are 2 rows of 3 cameras. The cameras as fixedly held so their individually generated images shows overlap with another camera both in horizontal and vertical direction. The camera system may for instance be part of a smart phone or a tablet. FIG. 4 shows in diagram a front view of the cameras system showing as circles the cameras or rather symbolically lenses of the cameras. FIG. 5 show a side view of a row of 3 cameras on the system. It shows the lenses having a relative rotational position relative to each other in order to create the required image overlap. The second row of cameras is assumed but not shown in order not to overcrowd the diagram. The second row may be similar. However the first and second row of cameras also have a rotational position relative to each other to ensure vertical overlap.

FIG. 3 shows in diagram a representation of the image sensors of the individual cameras. It should be understood that the drawing is a schematic representation. The shape of the image sensor is usually rectangular and in some cases may be square. The drawing identifies 6 cameras. Each camera has an image sensor. The image sensors IS 1, IS 2, IS 4 and IS 5 of camera 1, camera 2, camera 4 and camera 5, respectively are identified. The image sensor diagram represents the grid of photo-diodes in a CMOS image sensor for instance. Each pixel has a coordinate (x,y) in that grid. A real image sensor also has other circuitry on board. But for clarity these are ignored in the drawing, but of course in reality are present. The diagram of FIG. 3 shows by the striped section a window in an e-gimbal at a certain moment. Clearly the window is formed by sections of IS 1, IS 2, IS 4 and IS 5. It may be assumed that the system is now programmed with its effective edges for harvesting scan-lines of the image sensor. In accordance with an aspect of the present invention, the system, after determining the corners (x1,y1), (x2,y2), (x4,y4) and (x5,y5) in their respective individual image sensor implements these coordinates in real-time as required start or end points of the scan-line control. This means that in accordance with an aspect real-time only the image data representing the window is harvested. This enables a real-time, window-based e-gimbal system. It should be noted that the configuration shown in FIG. 3 is merely illustrative. Other configurations, such as 2×2, 3×3, 4×4 arrays, or alternative arrangements of image sensors, are fully contemplated within the scope of the present invention. The principles described herein apply equally to such configurations, and the system may be adapted accordingly to determine and implement the relevant coordinates for scan-line control.

An MLP, or Multilayer Perceptron, herein is a feedforward neural network composed of fully connected layers. It is a tool for learning nonlinear mappings between structured inputs (like sensor data) and outputs (like pixel coordinates in extended image space). An MLP in a calibration pipeline may as Inputs have: Structured sensor data, IMU orientation (e.g., pitch, roll, yaw or quaternion), GPS coordinates, Compass heading and optional: camera pose or metadata. MLP architecture includes an input layer: accepts the full vector of sensor data; hidden layers: multiple fully connected layers with nonlinear activation functions (e.g., ReLU, GELU); and output layer: predicts pixel coordinates (e.g., x,y) in extended image space.

An MLP herein may provide 1) Sensor-to-coordinate mapping: MLPs are enabling for learning relationships between structured numerical inputs and continuous outputs. 2) fast and lightweight: compared to CNNs or Transformers, MLPs are computationally efficient-great for real-time deployment; and 3) Generalization: with enough training data, an MLP can generalize across different poses and environments. One may use an MLP to predict the location of a calibration marker in image space based solely on sensor data; serve as a submodule in a larger system (e.g., combined with CNNs that process image features); and provide a fast initial estimate that a more complex model refines.

In one embodiment, the neural network is trained using a supervised learning approach. The training objective is to minimize a loss function that reflects the discrepancy between predicted and actual marker locations in the extended image space. For coordinate-based outputs, the loss function may include a regression term that penalizes the Euclidean distance between predicted pixel coordinates and ground truth coordinates. This may be implemented using a mean squared error (MSE) or a smooth L1 loss function, both of which are standard in the field of computer vision and known to a person having ordinary skill in the art.

In embodiments where the network predicts heatmaps or probability distributions over pixel locations, the loss function may include a pixel-wise binary cross-entropy term. This term penalizes incorrect predictions of marker presence or absence across the image space. Optionally, a focal loss may be used to emphasize harder-to-detect markers, particularly in cases of class imbalance or sparse marker distribution.

In multi-task configurations, the loss function may combine multiple objectives, such as location regression and marker classification. In such cases, the total loss may be expressed as a weighted sum of individual loss components, with weighting factors selected empirically or adaptively during training. For example, the network may jointly predict the pixel location and identity of each marker, and the loss function may include both a regression term and a categorical cross-entropy term.

In some embodiments, the network may also output a confidence score or uncertainty estimate for each prediction. In such cases, the loss function may incorporate a heteroscedastic regression term, which adjusts the penalty based on the predicted uncertainty. This enables the model to express varying levels of confidence across different spatial regions or sensor conditions.

The choice of loss function may vary depending on the architecture used (e.g., convolutional neural network, vision transformer, encoder-decoder) and the nature of the output (e.g., coordinates, heatmaps, labels). A PHOSITA would recognize that these loss functions are interchangeable and may be selected based on implementation-specific considerations without departing from the scope of the invention.

In the above, an electronic replacement has been provided of a standard mechanical gimbal which keeps position relative to the horizon and which is operated by one or more trained neural networks. In general users hold the camera relatively stable as to roll of the cameras and usually pitch and yaw changes are the most severe. However, roll may be significant also. Traditional real-time computerized methods for image rotation are well known. In that sense, one may measure camera roll and perform counter-roll in real-time using known methods. One may assign one or more dedicated processing core for roll correction to align an image back with a horizon. Practically it requires an initial cut-out that is bigger than the corrected image to create the right size display image. One may use standard de-rotation image algorithms with parameters depending on the required angle of de-rotation, as is known in the art of image processing and is for instance available in OpenCV.

In accordance with an embodiment one may train a neural network to perform the so called de-rotation of an image in a rotated cameras, based on the measured rotation. The rotation angle relative to for instance a horizon is determined by an IMU unit with for instance a gyroscope. The NN system then is trained with artificial scenery containing high level of lines, curves and other details being presented in different angle of rotation with the scenery in unrotated condition as the ground truth. One may use a set of several hundreds of different sceneries to associate the de-rotation based on an input of the rotation parameter. This makes the de-rotation independent of the scenery.

Given an input image/rot rotated by angle θ. The rotation angle θ (from IMU). Produce: a de-rotated image/corrected aligned with the horizon. Its components include: an input layer that accepts rotated image and rotation angle, angle embedding that encodes scalar angle into a feature vector, a feature extractor such CNN backbone (ResNET or EfficientNet) to extract image, feature fusion that combines image features with angle embedding, a transformation head predicts pixel-wise transformation or flow field for de-rotation, a warping module applies predicted transformation to input image, and the output layer that produces the corrected image aligned with the horizon.

A training setup includes loss function: Combination of pixel-wise MSE and perceptual loss (e.g., VGG-based), data augmentation: random rotations, lighting changes, noise, ground truth: unrotated version of each scene, Optimizer: Adam or AdamW, learning rate: for instance start with 10\hat{ }−4, use cosine decay or scheduler, use cosine decay or scheduler. Operational use: at runtime: IMU provides roll angle θ, cameras capture rotated images and provide the extended panoramic image, neural network receives the image data and θ and outputs corrected image. This is one of several possible embodiments. One may consider also U-Net variant for pixel-wise flow prediction instead of affine transformation. Or a GAN-based enhancement for sharper outputs.

One may apply a Canvas Strategy: Diagonal-Based Projection to accommodate rotation without clipping: For an input image of size W×H compute the maximum diagonal D and use a square canvas of size D×D to embed the rotated image. After de-rotation, crop back to the original W×H size. This ensures that no content loss during rotation. consistent output dimensions and efficient cropping post-inference. Real-time optimization steps: Use MobileNetV2, EfficientNet-lite, or a custom CNN for low-latency inference, quantize model for deployment (e.g., INT8 via TensorRT or ONNX), precompute affine matrices for common angles if latency is critical and use GPU or dedicated neural core for inference.

In one embodiment one may divide the extended image canvas into discrete regions (e.g., 10×10 grid). Each region has precomputed or learned de-rotation parameters based on its position relative to the center of rotation. When an active window is selected, the system: locates the window's region; applies only that region's correction; and extracts the corrected window for display or processing. Implementation Strategy; 1. Canvas partitioning: divide canvas into N×M regions wherein each region R{i,j} stores rotation center offset, correction matrix or affine parameters and optional neural refinement weights. 2. Window localization uses pose prediction to locate active window and determines which region R{i,j} contains the window center. 3. Local de-rotation: apply only the transformation for R{i,j}, use affine warp or neural inference to correct the window and crop and output corrected image. One may train a lightweight neural module to predict region-specific de-rotation parameters and refine classical affine transforms based on local features and also Learn spatially variant correction patterns across the canvas. This allows the system to adapt to lens distortion, parallax, or sensor misalignment. It provides advantages such as real-time performance: Only a small region is processed per frame, modular design: each region can be optimized independently, Scalable: works with high-resolution or multi-camera systems and Hardware-friendly: ideal for parallel processing or tile-based architectures. Optional enhancements may include overlapping regions: smooth transitions between adjacent zones, confidence weighting: blend corrections from neighboring regions and dynamic region sizing: Smaller regions near center, larger at periphery. This embodiment transforms an e-gimbal into a region-aware vision system, capable of fast, localized correction without the overhead of full-frame processing. It's a fusion of geometric insight and neural adaptability.

One may store the extended image space in memory (e.g. as a 2D array or framebuffer). Then using the predicted window coordinates as corner addresses is provided as an efficient way to extract the relevant image data. The extended image space is stored as a 2D array in memory where each element is a pixel (e.g. RGB or grayscale). The neural network outputs a center coordinate. One defines a window size: w×h. 1. compute window corners; 2. extract subimage, this gives one a cropped region from the extended image space. The system can now pass window to any downstream module (e.g. display, classifier, encoder). and 3. Optional: store or stream: store in buffer, stream to display, and/or Feed to another model. If working closer to hardware (e.g. FPGA, embedded system), one may treat the image as a linear memory block and compute addresses like image stored as a flat array and each pixel at (x,y) (x, y) has address: addr=y*width+x. So for a window: top-left corner: addr_start=y_start*width+x_start, bottom-right corner: addr_end=y_end*width+x_end. One may then then iterate over rows. Use DMA to copy window block if working on embedded systems. Double buffering: for real-time systems, use two buffers to avoid read/write conflicts. Fixed-point math: If NN outputs floating-point coordinates, convert to integer safely.

It was described above how an extended image space was created for multiple cameras. This is based on creating the extended image space from identical cameras with known parameters and methods to determine scan-lines of individual camera image sensors that when harvested create a real-time panoramic image. One aspect there in is that scan-line programming in essence happens once, stays the same for multiple uses and can be upgraded later by recalibration for instance through Reinforcement Learning. However, an e-gimbal only displays effectively a part of the extended image space, so why process all this data just for a smaller window. For that reason, a camera system is provided with at least 2 rows of cameras like a 2 by 2 grid, a 2 rows 3 column grid or a 3 rows 3 column grid or even bigger as an n rows k columns grid of cameras with overlap. For the earlier disclosed processes to create an extended image space that doesn't make much difference, because only adjacent areas have to be considered and processed. And one may assign one or more processor or processor core to each image area. As one preferably processes relatively small strips of data the process essentially works in a similar manner. However, for an e-gimbal one may apply the following embodiment that updates a scanline instruction (for instance where to start and where to end on a line) per scanline or per frame of harvesting data from an image sensor. An e-gimbal as disclosed herein creates a window that holds an image of a specific pointing direction that may hold an object. The window should preferably be a standard image size of a video frame. Thus, one knows in that case that for instance in a 3 by 3 camera configuration, with a standard 1 camera display window that overlap may occur with 4 camera fields: two vertical ones and 2 horizontal ones. In that case, one would like a processor to create a map of the optimal regions of interest (ROI) that need to be scanned and generate the scanning instructions for each of the cameras that will achieve that. Thus only relevant image data is generated that will be processed rather than the entire extended image space. It requires for each image sensor scan control to be easily programmed and updated. The program instructions may change with each new frame. So, with a reconfiguration of the image sensor control which may require new hardware design and/or chip design, one may gain an enormous speeding up of processing performance and efficiency.

In one embodiment one may apply Reinforcement Learning Integration. RL agents may be trained to optimize scanline instructions over time. RL Learns which regions are most likely to contain relevant data and Improve efficiency and responsiveness with experience.

A Camera Space Distribution Module computes how the desired window (centered via IMU-based projection) is distributed across the camera grid, and to determine which cameras contribute pixel data and which regions (scanlines and horizontal bounds) are relevant per camera. The inputs are window center and size form the positional mapping module, camera grid metadata with parameters and overlap maps, the extended image space geometry that defines how camera views tile together. The processing steps include: 1. Project window bounds which compute the 2D bounds of the window in extended image space, typically a rectangle centered on the pointing vector. 2. Intersects with camera fields, and for each camera includes transforming window bounds into the camera's local coordinate space, determining if there's an intersection and If yes, compute start and end scanlines and horizontal pixel bounds. This module is a bridge between global pointing and local harvesting. It translates a geometric window into actionable scanline instructions for each camera, enabling selective data acquisition, parallel processing and efficient stitching. A predictive model can smooth noisy IMU data and forecast short-term motion trends, improving scanline selection stability.

A Predictive Window Estimator Uses IMU data+scanline history and applies Kalman filter (or alternatives like particle filters, LSTM-based predictors). it outputs estimated future window center in extended image space. It acts as a temporal stabilizer, reducing jitter and improving scanline harvesting consistency. The RL Agent (Policy Network) uses as Input predicted window center. Camera grid layout and temporal context (e.g., velocity, acceleration). The action space for each camera includes select scanline bounds (start/end). It has as reward function coverage of predicted window, efficiency (minimal scanlines) and temporal smoothness (avoid erratic jumps). Kalman filters add robustness to noisy IMU data, prediction enables proactive scanline selection and RL agent learns to optimize not just for coverage, but for temporal consistency.

It is believed that a person of ordinary skill in Reinforcement Learning is able to design in detail and RL Agent for scanline harvesting optimization. As an illustrative example more details are provided below. An objective is to learn to select the minimal set of scanlines across relevant cameras that fully cover the predicted window, minimize latency, bandwidth, and power, and maintain stitching quality and temporal consistency. 1. State Space. The state represents all the information the agent uses to make decisions. This includes the predicted window center in extended image space, the window size with width and height of a desired ROI (region of interest), the camera grid lay-out with grid position and overlap maps, camera parameters such as intrinsic/extrinsic matrices, previous scanline actions, a motion vector from IM or predictive filter with for instance velocity and acceleration, and frame index and time delta for temporal context. One may encode this as a structured tensor or flatten it into a vector depending on the RL algorithm. 2. Action Space. The agent outputs scanline harvesting instructions per camera. It has as action format for each contributing camera a start scanline: Integer from 0 to max height, an end scanline: Integer from start to max height, an optional horizontal bounds: start and end pixel columns. The action space type is discrete: predefined scanline ranges (e.g., 8 bins per camera), or continuous: real-valued scanline indices normalized to [0, 1]. Discrete actions are easier to train; continuous actions offer finer control. 3. Reward Function where the reward guides the agent toward efficient and accurate scanline selection. Reward components may include coverage reward, efficiency reward, latency reward, stitching quality and temporal smoothness. A possible illustrative reward formula may be: reward=coverage_score*1.0−scanline_count*0.01−estimated_latency*0.1+stitching_bonus−jitter_penalty.

One may normalize or clip rewards to stabilize training. A training strategy may include as environment: simulated multi-camera grid with synthetic pointing vectors; as algorithm: PPO (Proximal Policy Optimization) or SAC (Soft Actor-Critic); with episodes: each frame is a step; episodes span multiple frames and exploration: use entropy regularization or epsilon-greedy sampling.

An RL architecture may be employed to determine scanline harvesting instructions based on the placement of a predicted window across a grid of camera image spaces. Alternatively, a Convolutional Neural Network (CNN) may be used to predict the optimal Region of Interest (ROI) location and size from fused multi-camera inputs, map the predicted window onto the camera grid layout, and estimate coverage masks or scanline importance scores. This approach is efficient and deterministic, and may be applied to static inference tasks such as identifying where the window should be placed. In contrast, reinforcement learning excels in adaptive control scenarios. An RL agent can dynamically select scanlines based on motion, latency, and stitching constraints; adapt to changing conditions such as motion blur, occlusion, or lighting variation; and optimize trade-offs between coverage, bandwidth, and power consumption over time. This makes RL particularly suitable for real-time decision-making in dynamic environments. A hybrid strategy may also be contemplated, wherein a CNN predicts the ROI window and generates a coarse scanline importance map, which is then fed into an RL agent that performs fine-grained scanline selection. This hybrid architecture combines the spatial precision of CNNs with the temporal adaptability of RL agents. Accordingly, while the RL-based solution described herein serves as an illustrative example of learning-based window location programming, alternative approaches including neural network inference and hybrid learning architectures are fully contemplated.

In a next embodiment a shift is made from a passive horizon-focused mode to an active object-tracking mode, which transforms the e-gimbal into a dynamic, intelligent system that can follow targets in real time. This addition not only expands the use cases (e.g., surveillance, autonomous navigation, cinematography) but also showcases the robustness of your extended image space design.

Object Tracking Mode for E-Gimbal System. In addition to horizon-focused operation, the e-gimbal system may operate in an object-tracking mode, wherein the center of the scanline harvesting window is dynamically aligned with a tracked object in extended image space. An object tracking algorithm—such as Kernelized Correlation Filters (KCF), MOSSE, Siamese networks, or other suitable methods—may be trained or applied to identify and follow the object across frames. The tracker outputs the object's bounding box or kernel, and the center of this region is used to position the window.

Due to the large size and coverage of the extended image space, the system can reliably maintain the object within view even under conditions of: Camera motion (e.g., pan, tilt, vibration), object motion (e.g., walking, driving, flying) and scene complexity (e.g., clutter, occlusion). This enables robust tracking without requiring mechanical gimbal movement, relying instead on intelligent scanline harvesting and electronic window repositioning. The object-tracking mode may be integrated with the RL agent described above, allowing the agent to optimize scanline selection around the tracked object while minimizing latency, bandwidth, and power. Alternatively, a CNN or hybrid model may be used to assist in object localization and scanline prioritization.

A hybrid tracking architecture combines the strengths of both CNNs and classical trackers like KCF or MOSSE. Use a CNN for object detection at keyframes or when uncertainty is high, and KCF/MOSSE for fast tracking between those detections. The CNN acts as a “correction” or “reinitialization” mechanism. System Workflow: Initial Detection (CNN) which includes detecting object using a CNN (e.g., YOLO, Faster R-CNN), getting a bounding box and object center, and initializing KCF/MOSSE tracker. Tracking Phase (KCF/MOSSE): track object across frames, predict object movement based on previous velocity, and update object center in extended image space. Confidence Check: periodically or conditionally (e.g., low confidence, occlusion, abrupt motion), re-run CNN, compare CNN detection with tracker prediction, and If mismatch exceeds threshold, reinitialize tracker. Spatial Prediction: Use motion model (e.g., Kalman filter or simple velocity extrapolation) to predict likely object location, CNN focuses detection on predicted region (reduces compute). Extended Image Space Mapping: Use calibration to project local coordinates to global extended image space. Trigger scanline harvesting or windowing logic.

Why this works well. CNN detection provides robustness to occlusion and appearance changes but is somewhat slower. KCF/MOSSE or other tracking is fast lightweight and operates real-time, but is sensitive to drift. A hybrid approach balances speed and robustness. To further improve: adaptive CNN Invocation: only run CNN when tracker confidence drops or motion exceeds threshold. Region Proposal from Tracker: use KCF output to define CNN search region. Think of the CNN as a spotter and KCF as a sprinter: The spotter (CNN) occasionally checks the scene and gives precise updates. The sprinter (KCF) runs fast and keeps up with the object until it loses track. Together, they cover both speed and accuracy.

Training and activation flow for Hybrid Object-Tracking E-Gimbal. The training phase prepares the system for deployment by training the CNN and calibrating the extended image space. 1. Extended Image Space Calibration may include calibrating intrinsic and extrinsic parameters of all cameras, generating overlap maps and spatial transformations and defining global coordinate system for panoramic stitching. 2. CNN Training (Object Detection) may include collecting labeled data across varied scenes and lighting, training CNN (e.g., YOLO, Faster R-CNN) to detect target objects, optimizing for bounding box accuracy and inference speed and optionally training on cropped regions from extended image space. 3. Motion Model Calibration may include collecting IMU data during camera movement, training or tuning Kalman filter or velocity extrapolation model, validating prediction accuracy for object movement. 4. RL Agent Training (Optional) may include simulating scanline harvesting environment, training RL agent to optimize scanline selection around object, and using reward function balancing coverage, latency, and efficiency. The activation/runtime phase is where the system operates in real time to track objects and harvest image data efficiently. 1. Initial Object Detection: CNN scans full or partial extended image space, detects object and outputs bounding box and center, projects center to global coordinates and initializes KCF/MOSSE tracker with bounding box. 2. Tracking Loop with: KCF/MOSSE tracks object across frames, updates object center in extended image space, predicts next location using motion model (Kalman filter), and adjusts window position accordingly. 3. Confidence Monitoring for evaluate tracker confidence (e.g., response map strength). If confidence drops or motion is erratic: CNN re-detects object in predicted region and compares with tracker output. Reinitializes tracker if mismatch exceeds threshold. 4. Scanline Harvesting for using updated object center to compute window bounds, Camera Space Distribution Module identifies contributing cameras, RL agent (if used) selects optimal scanlines per camera and Harvest pixel data and render/display window. 5. Adaptive Optimization and CNN invocation frequency adapts based on tracker stability, RL agent refines scanline selection over time and system maintains object-centered view with minimal latency.

Once the window location has been established with the required scanlines, the image data is harvested in accordance with the scanlines and displayed as an image. Thus creating a display of the object or location that is being tracked by the e-gimbal.

Automatic Tracking and Human Identification Based on Combination Between YOLO and KCF Algorithm, W Lan, Y Li, Z Hu, D Wang, Y Du, Y Wang, K Li, International Conference on Man-Machine-Environment System Engineering, 2024, Springer, which is incorporated herein by reference discloses a system that combines YOLO (CNN-based detection) with KCF tracking for automatic tracking and human identification. An article “An Active Multi-Object Ultrafast Tracking System with CNN-Based Hybrid Object Detection Researchers, Qing Li et al, September 2023 and downloaded from Sensors 2023, 23(8), 4150; https://doi.org/10.3390/s23084150, which is incorporated herein by reference, discloses a CNN-based hybrid tracking system. A GitHub project integrates YOLOv5 with traditional trackers like KCF, MOSSE, and CSRT, along with a custom Kalman filter. It uses sparse CNN detections and continuous tracking to optimize performance. One may download the software from https://github.com/AidaAriafar/YOLOv5-Hybrid-Object-Tracking and is incorporated herein by reference.

The described e-gimbal system comprises a fixed multi-camera array with overlapping fields of view. Leveraging its known geometric configuration and the ability to dynamically control scanlines at the sensor level, the system constructs an extended image space-effectively a real-time video space with panoramic coverage and intelligent focus. This system advances beyond conventional gimbal and tracking architectures through several key innovations: Extended Image Space Integration: Unlike traditional systems that rely on mechanical movement or limited fields of view, this system electronically stitches and navigates a global image space using scanline harvesting. Scanline-Level Control: Fine-grained control over individual image sensors enables dynamic windowing and object-centric rendering without mechanical latency. Multi-Camera Coordination: Cameras contribute selectively based on object location and scanline relevance, optimizing bandwidth and power.

Reinforcement Learning Optimization: An RL agent intelligently selects scanlines and adjusts window positioning to balance latency, coverage, and efficiency.

Hybrid Learning-Based Processing: Traditional algorithmic pipelines are replaced or enhanced by trained models using supervised, unsupervised, and reinforcement learning. This allows the system to generalize across scenes, relying primarily on physical system parameters. Training vs. Runtime Efficiency: While training pipelines may be computationally intensive and time-consuming, they are performed offline in controlled environments. Once trained, the system operates with exceptional speed and responsiveness. Deployment is streamlined via: Component Reusability: common hardware and software modules allow rapid scaling. Calibration via Display Scenes: Fine-tuning can be performed using known calibration scenes projected on large displays.

Edge Computing Compatibility: For high-resolution or low-latency applications, edge processing may be used initially. However, the system remains fully autonomous and self-contained. Future Scalability. Given the rapid evolution of neural processors and on-chip AI accelerators, it is anticipated that within 3-5 years, such systems will be compact enough to be embedded directly into consumer devices such as smartphones. This opens the door to widespread adoption in fields ranging from mobile cinematography to autonomous navigation and augmented reality.

One aspect of the present invention is the control of the scan-line setting in an image sensor. This is usually controlled by a register in an addressing scheme in a control unit of an image sensor. One may find that described in the data sheets of advanced image sensors. This includes for instance the datasheet of: CIS2521F (Fairchild Imaging), downloaded from https://www.sunnywale.com/uploadfile/2023/0513/CIS2521Fxxxx % 20Standard %20and%20Scie ntific%20Package%20Datasheet_RevE_Awin.pdf, the PYTHON 480 (onsemi), downloaded from https://www.onsemi.com/download/data-sheet/pdf/noip1sn0480a-d.pdf, and KAI-08050 (onsemi), downloaded from https://machinevisionstore.com/content/downloads/OnSemi/KAI-08050-Datasheet-PS-0011-r6-0.pdf. An implementation of an image sensor (the CIS2521F) in a camera is explained in a datasheet of the MityCam camera disclosed in https://www.1vision.co.il/pdfs/criticallink/datasheet/mitycam-b2521f-datasheet.pdf. All these datasheets are incorporated herein by reference.

Control of Scan-Line settings and ROI programming in image sensors. One aspect of the present invention concerns control of scan-line settings, commonly referred to as the region of interest (ROI), in image sensors. In conventional devices, ROI is typically programmed via register writes over control interfaces such as I2C or SPI. Examples of such implementations are illustrated in datasheets for image sensors including: CIS2521F (Fairchild Imaging), PYTHON 480 (onsemi), KAI-08050 (onsemi). A camera implementation using the CIS2521F is described in the datasheet for the MityCam B2521F camera system. Each of the aforementioned documents is incorporated by reference in its entirety.

Limitations of conventional ROI programming. In many conventional designs, ROI configuration occurs infrequently—for instance, at initialization—and is not updated per frame. SDKs may abstract register-level access into high-level APIs, but real-time (frame-by-frame) programming is typically unsupported. Registers may be inaccessible through standard SDK calls, which is a result of design intent rather than a functional deficiency.

Real-time ROI update mechanisms. In certain embodiments of the present invention, ROI parameters are updated in real-time on a per-frame basis in the scan-line control pf individual image sensors. Techniques include: vertical blanking updates: ROI parameters are rewritten during the vertical blanking interval and committed at frame boundary. Double-buffered coordination: NEXT_ROI is loaded while ACTIVE_ROI is rendering; buffers swap at frame sync. Non-blocking register access: SDK or driver interfaces may support timed burst or interrupt-safe updates. An optional implementation uses dedicated high-speed addressable memory to buffer ROI settings. A controller or DMA engine reads from this buffer to apply scanline limits deterministically.

Dedicated ROI Interface via chip pins or pads. In accordance with another aspect of the invention, scan-line (ROI) configuration is facilitated via dedicated physical interface lanes, such as pins or pads on the sensor chip. These interfaces enable low-latency, per-frame updates through: Static edge-coordinate pins (SECP). These define fixed region bounds (e.g., top/bottom rows, left/right columns). They are latched at boot or via low-frequency config bus. And are updated less frequently. In yet another embodiment frame-programmable variable pins (FPVP) are provided. These provide per-frame coordinates or dynamic ROI offsets. They may be sampled during vertical blanking (VBLANK). And they may be activated at next FRAME_SYNC. They may include: hardware clamping to SECP-defined limits, parity or CRC error checking and watchdog reversion to safe ROI on invalid updates.

Instructional considerations and ROI behavior in an example signaling protocol may include: host drives FPVP during VBLANK, At next FRAME_SYNC, buffered ROI becomes ACTIVE_ROI, and external strobe optionally latches double-buffered ROI. It optionally may include: Mixed-mode updates (e.g., static columns+variable rows, or vice versa), multi-window scheduling using independent FPVP lanes for each region ID, round-robin arbitration between FPVP update lanes, and latency guarantees between ROI latch and application. Non-limiting implementations. The foregoing interfaces and protocols are illustrative and non-limiting. Equivalent implementations (e.g., serialized FPVP lanes, memory-mapped ROI FIFOs) may substitute without deviating from the scope of the present claims. Where incorporated references describe ROI via register maps, such control may be achieved via the disclosed physical or logical interfaces. A key element in at least one embodiment is the creation of instantaneous access (within at least one frame period) and programming of ROI control of an image sensor or what is called above scan-line determination or scan-line control.

Conventional image sensor chips typically rely on a high lead count to interface with external control systems. This may make dynamic or real-time Region of Interest (ROI) input a challenge. One embodiment of the present invention addresses this by enabling ROI delivery through a minimal number of leads via pad multiplexing and timing-controlled double-buffered registers. This reduces dedicated pin requirements, allows deterministic ROI updates synchronized with frame capture, and ensures compatibility with legacy pad assignments, thereby enhancing flexibility without compromising performance. Existing image sensors often lack a flexible way to deliver dynamic ROI coordinates without consuming excessive leads or causing timing issues. This is not a flaw, but based on prior art not requiring real-time update of scan-line settings. One may use multiplexed chip pads that support both standard I/O and high-speed ROI data delivery. A relatively small number of dedicated leads (e.g., 3-5) may enable ROI updates via serial or low-pin parallel interface. The coordinate space of an image sensor requires about 12-14 bits per coordinate. A coordinate update needs to take place within one blanking period. Based on that one may compute an optimal time and lead ratio. A 3-5 lead assignment will work very well within the earlier explained conditions. One may include double-buffered ROI registers latched on frame sync, ensuring deterministic updates without interrupting capture. This Reduces lead overhead in packages already exceeding 160 pins. It Enables dynamic ROI changes without frame drops. And it is Compatible with existing pad layout via muxing strategies. For example, assuming a 28-bit ROI coordinate pair (14 bits each for x and y), and a blanking interval of 1 ms, even a 3-wire serial interface operating at 10 Mbps per line can transfer ^{˜}30,000 bits in that period—sufficient for real-time ROI updates.

Some practical limitation may be illustrated with the following illustrative example. Object tracking is achieved with a bounding box in extended image space. A tracking algorithm (like a hybrid YOLO/KCF system) identifies the location of the moving object's bounding box within the panoramic extended image space. This provides a set of four coordinates representing the corners of the box in a single, unified coordinate system. Next, the system uses its pre-calibrated knowledge of the camera array to translate the panoramic bounding box coordinates back to the local coordinate system of the individual cameras. Boundary calculation: Because the system knows the physical boundaries of each camera's “active image space” within the panorama, it can determine which cameras are “seeing” the object. If the bounding box is smaller than a single camera's image, it may be visible in no more than four cameras at a time in a 3 rows by 3 columns cameras system as depicted in FIG. 3. Corner computation: The system computes the precise coordinates of the bounding box's corners within the image space of each individual camera that contains part of the object. Real-time scan line programming. Instead of capturing and processing the entire frame from every camera, the system only programs the scan lines of the relevant cameras to read out the image data within the newly computed bounding box. Dynamic ROI: The camera sensors are instructed to create a dynamic Region of Interest (ROI) based on the bounding box coordinates. This effectively limits the amount of data being “harvested” to only what is necessary for the next frame's tracking. Efficiency: This dramatically reduces the amount of data that needs to be transferred and processed. It minimizes computational load, which is a major advantage for high frame rate, real-time applications. By continuously updating these scan line limitations per frame, the system acts as an e-gimbal. It's not physically moving a camera, but it's achieving the same effect: keeping the object's bounding box centered in the combined extended image space by “following” it with the scan lines of the camera array. The result is a stabilized, tracked image of the moving object that's far more efficient than processing full frames from all nine cameras.

One practical condition of an illustrative 3 by 3 cameras system is a 2-degree per frame traversing limit. A change of 2 degrees per frame is a significant value in a real-time system. At a standard video frame rate of 30 frames per second, this means your e-gimbal can track an object moving at up to 60 degrees per second. This is a high-performance specification that's well within the range of what a highly optimized software-based system can achieve, especially with a dedicated processor. Pixel-based calculation: This can be translated into pixels per frame. If a single camera's field of view is, for example, 60 degrees, and its resolution is 4K (3840 pixels horizontally), then 2 degrees of movement would equate to: (2∘)×(3840) pixels/60∘=128 pixels/frame. This shows the system must be capable of processing and reacting to large pixel shifts between frames. This is a very achievable goal for a hybrid YOLO/KCF system. An object size limitations requirement may be that the object be ½ to ⅛ of a single camera image dimension. Tracking robustness: an object of this size is large enough to contain rich features (like color, texture, and shape) for the tracking algorithm to lock onto. It prevents the system from getting confused by noise or small, irrelevant details. Bounding box stability: a bounding box that's roughly ¼ of a camera's image area is still small enough to be contained within four cameras at most, even when it's at the center of a quad intersection. This confirms your initial assumption and simplifies the logic for mapping the bounding box to individual cameras. Computational efficiency: a smaller object size means the search window for the KCF tracker can be kept relatively small, reducing computational load and allowing for faster processing. The YOLO model also performs better on objects of a reasonable size, as very small or very large objects can sometimes be more difficult to detect accurately.

Thus, a maximum tracking speed of 60 degrees per second and object image sizes of approximately ⅛ of a single camera's image dimension or greater represent practical and achievable parameters. These values reflect performance levels that a processor-based system may attain with relative ease. However, both KCF and YOLO—particularly newer versions and when applied to objects with distinguishing visual features—may support tracking of smaller objects, down to approximately 32×32 pixels, and in some cases as small as 16×16 pixels.

Accordingly, the illustrative example provided herein should not be considered limiting. It is understood that smaller object images may present challenges, particularly in low-contrast environments or against complex backgrounds. Nonetheless, under reasonable operating conditions, the system performs effectively and reliably.

The above in its entirety provides an e-gimbal that may be realized with a variation of practical implementations. In review: A scene-invariant, deep learning, such as reinforcement-learned or deep neural network trained, control system is provided for a panoramic multi-sensor imaging array, trained using high-resolution geometric ground-truth scenes and camera model parameters, in a camera system with 2 or more cameras in a fixed position with overlap in images created with the 2 or more cameras. The training is applied to achieve Adaptive alignment and region-of-interest selection independent of scene content. The system is trained to create a scenery invariant extended image space controlled by camera parameters, based on learned one or more image sensor edges that determine scan-line limitations of individual image sensors. A real-time panoramic video image is formed by combining image data harvested only from image sensor regions defined by learned scan-line limitations. An initial preferred image capturing window within the extended image space is set and associated with a position in space of the camera system. The cameras system may move and computes or determines by deep learning where the image window will move to in extended image space as a result of the camera system movement.

The camera system is trained by deep learning to apply scanline settings to individual image sensors to scan only image sensor areas to generate image content inside the moved camera. In one embodiment a capturing window is based on an object and/or a location. In another embodiment the capturing window is associated with a moving object. Scan-line limitations set in an image sensor is updated real-time and at least within a video-frame period.

Technical components include training dataset with high-resolution panoramic ground truths containing detailed line/curve geometry and illumination variations; does not depend on semantic scene features (like people, vehicles, etc.). Simulation environment includes modeling physical camera parameters (focal length, exposure, shutter, noise); and providing camera-specific observations and feedback. Neural policy for learning to align sensors, set ROIs, and control image acquisition based solely on internal camera parameters and learned spatial models. Deployment behavior, at runtime, system receiving camera parameter inputs (not scene content) and outputs aligned ROI commands for each sensor. No need for scene-dependent feature detection or inference. Scene-Invariant e-gimbal where ROI updates simulate camera panning/tilting across stitched views—not based on objects in the scene, but on geometric continuity and internal consistency. In another embodiment a capturing window is based on tracking an object for instance with KCF tracking and/or YOLO detection/tracking.

The inventor's prior work (e.g., US20250013141A1) discloses a system for multi-camera alignment and ROI control using conventional image processing techniques. The present invention builds upon that foundation, introducing a learning-based control architecture that replaces deterministic logic with a reinforcement-learned policy. This transition enables scene-invariant operation, real-time adaptability, and significantly enhanced robustness across diverse environments. While effective within calibrated and controlled environments, the earlier e-gimbal system depend on scene content, deterministic alignment logic, and often may require manual reprogramming or recalibration in the face of environmental drift, optical variation, or unexpected input conditions. There is no doubt in the inventor's mind that the earlier inventive concepts and embodiments work very well. Aspects and embodiments of the present invention overcome some structural limitations by replacing scene-dependent logic with additional machine learning such as a reinforcement-learned policy trained on high-resolution geometric panoramas and camera model parameters. As a result, the system becomes content-invariant, self-correcting, and capable of robust, flexible deployment without ongoing manual tuning. This constitutes a significant departure from prior deterministic methods.

As a training model one may use sets of different artificial sceneries with high detail content such as lines, curves, and shapes, distributed over a large canvas that forces the cameras system to break up the image and align its parts based on camera or camera related parameters rather than content. To prevent over-fitting as is known in the art, one may generate at least a 1,000 different sceneries with detailed content. One embodiment may use for instance 100 carefully designed different sceneries with high details in expected transition or overlap areas. These images or sceneries at the same time form a well-defined ground truth in a deep learning environment. One may then generate random sceneries from a set of pre-determined shapes, lines curves and the likes. One may use a random or pseudo random procedure to first generate a random set of shapes and a procedure to place these randomly determined shapes randomly on the canvas. One may use a 900 thus randomly created sceneries as training and ground truth images. One may use a large or very large video screen like 3 by 3 or even 5 by 5 meter or bigger to present the training sceneries. This allows for almost limitless number of training sceneries display. One may apply a two-step training model, particularly in the context of reinforcement learning for robotics and computer vision. It may be commonly known by the term “sim-to-real” (simulation-to-real-world) transfer. One may apply high-fidelity simulations that enter the image data directly into the training system without a need for displaying images on a screen.

However, a model trained purely in a perfect, noiseless simulation may fail when deployed on a real camera. This performance degradation may be called the “reality gap”. The gap exists because simulations cannot perfectly capture all the complexities of the real world, such as: sensor noise: All physical sensors have some level of random noise. Physical properties: minor discrepancies in mass, friction, and elasticity. Actuator lag: delays in how a motor responds to a command. And lighting and optics: Subtle variations in light, reflections, and lens distortions, for instance. A two-step approach to bridge the gap. Simulation pre-training: A first step is to train the policy in a simulation environment. This is where the model learns the core task, such as the geometric alignment and region-of-interest selection you described. This step is highly efficient because: data generation: thousands or even millions of training episodes can be run in parallel, far faster than real-time. Perfect ground truth: The simulation provides precise, unambiguous feedback and rewards. Safety: The model can fail and “crash” without any operational damage. Then apply fine-tuning/domain randomization: A second step is to adapt this pre-trained policy to the real world. This is where a few different techniques are used, and your idea of fine-tuning with real camera data is a common one. Other methods include: domain randomization: during the simulation training phase, researchers intentionally randomize key simulation parameters (e.g., lighting, textures, camera noise, sensor latency). This is to train the policy on a wide range of different “simulated realities” so that it learns to be robust and generalize to the specific, unknown parameters of the real world. fine-tuning: The pre-trained model is then fine-tuned with a small amount of data from the real hardware. This process uses the real camera's data to make minor adjustments to the model's weights, adapting it to the sensor's specific characteristics and imperfections. System Identification: This involves using a small number of real-world trials to precisely identify the parameters of the physical system (e.g., sensor noise models, camera calibration) and then retraining or fine-tuning the model using a more accurate simulation.

As used herein, “machine learning” refers to computational systems capable of improving performance on a given task through data-driven training, including but not limited to supervised learning, unsupervised learning, reinforcement learning, and self-supervised learning. Suitable machine learning models include convolutional neural networks (CNNs), recurrent neural networks (RNNs), vision transformers (ViTs), and other deep or shallow learning architectures. In some embodiments, machine learning models are used to extract spatial or temporal features from video frames captured by a multi-camera array. These features are used to align overlapping regions, estimate homographies, or generate panoramic views in real time.

In another embodiment, a reinforcement learning agent is used to simulate or optimize the behavior of a virtual camera operator, selecting stabilized views (“e-gimbal”) from the panoramic feed based on a learned policy. In one implementation, a convolutional neural network is trained on labeled panoramic datasets to learn feature correspondences between overlapping video feeds. Alternatively, a transformer-based network may be used for dense feature matching. Reinforcement learning models may be trained using a reward function that favors stabilized, centered views based on motion vectors or subject detection.

In one implementation, a convolutional neural network is trained on labeled panoramic datasets to learn feature correspondences between overlapping video feeds. Alternatively, a transformer-based network may be used for dense feature matching. Reinforcement learning models may be trained using a reward function that favors stabilized, centered views based on motion vectors or subject detection. All intended to lead to a spatial but feature independent alignment of images by learning and implementing scan-line control.

In preferred embodiments, the machine learning models are implemented using neural network architectures, such as convolutional neural networks (CNNs), recurrent neural networks (RNNs), transformer networks, or combinations thereof. However, in other embodiments, non-neural network machine learning techniques may also be employed where suitable.

Thus, As used herein, “machine learning” refers to any computational system that improves performance over time or with data. In the context of the present invention, machine learning models are employed to enable real-time panoramic image generation from multiple overlapping camera inputs, where the cameras are fixed in position.

In certain embodiments, the machine learning system is configured not only to estimate geometric relationships between frames or views but also to learn and implement image sensor scan-line control strategies. These strategies may dynamically adjust the exposure timing, readout order, or scan pattern of each image sensor to optimize alignment across cameras for seamless panoramic stitching.

Such sensor-level control, enabled by machine learning, allows the system to anticipate motion or misalignment between adjacent views and proactively adjust sensor behavior to minimize stitching errors in real time. In a further embodiment, real-time update of scan-line control enables creating a tracking window in an extended image space, which is called an e-gimbal herein.

The term ‘machine learning’ as used herein is intended to be interpreted broadly and includes any computational technique that enables adaptive behavior based on data, regardless of whether the underlying model is neural, statistical, symbolic, or hybrid.

After applying the above, a panoramic video image has been achieved from 2 or more cameras that covers an area of vision and of display that is greater than may be achieved with a single camera. By having fixedly attached cameras, for instance in a single common housing or single holding structure, one may rely on parallel processing and real-time generation of panoramic video images. Preferably, all processors are also contained in the common housing or holding structure. In the alternative a separate co-processing unit, which is preferably portable and mobile may attached and/or connected to the cameras to perform the processing. Such a connection may be a galvanic connection or a wireless connection. In that case the cameras off-load their data to the remote processing unit. A display screen may be located on the camera unit and the generated panoramic image may be transmitted back to the unit to be displayed on its screen. A screen may also be included with the processing unit, so that a panoramic video may be viewed on a local screen. A viewing screen may also be a remote screen that is connected with either the processing unit and/or with the camera unit and allows remote viewing of the panoramic video.

Display screens are generally configured to a fixed size image such as a square image, 1 by 1 in relative dimensions, to 3 to 4, to almost 1 (vertical) by 2 (horizontal). However, panoramic images, when displayed in horizontal format may be more of a 1 by 3 or even 1 by 4 or 1 by n with n being related to a number of cameras used. This requires either multiple screens or resizing of a panoramic image to be displayed fully on a screen. In general, on a standard screen, some black bars on top/bottom may be acceptable to view a panoramic image. A reason is that one would like to take an image to make sure that scene details that would normally fall outside a single camera view will be captured. This may be achieved by having at least 2 and preferably 3 cameras in a single structure or housing. Display may be achieved by resizing the generated image so that sufficient details in vertical direction are still visible.

It is different to what is preferably be watched on a screen and what is actually created and stored. In accordance with an aspect of the present invention a panoramic video is generated that would require multiple screens to have a full size display. Commonly a smartphone, a laptop or even most of standard desktop computers only has one screen. In accordance with an aspect of the present invention, a portion of the generated panoramic image is displayed that covers or substantially covers for preferably 60%, more preferably for at least 75% and even more preferably for over 90% the viewable area of the screen. A user may move, by way of a mouse instruction, or by moving a finger or pen or other object over a touch screen, the view of the portion of the panoramic video that has been generated. That is, for instance, if a generated panoramic video has a horizontal image size of 3 screens, by moving a focus area, one may display in full screen the outmost left size portion or the utmost right portion or any portion in between in full screen.

The creation of a full panoramic image may seem a waste to track only part of the image. But ultimately the cost of processors and memory will be cheaper than a mechanical solution for tracking, as illustrated by Moore's law. In fact the total increase in cost of the herein provided solution is marginal compared to benefits in stable image and tracking capability. Furthermore, only a portion of the panoramic image is actually used. For stabilization purposes, the processor may be instructed to process only those portions of the panoramic image that are relevant to the focus or stabilization area. This may further speed-up processing and lessen the demand on processing time.

Smart phones nowadays have a number of micro-electro-mechanical systems (MEMS) and sensors to determine a position, an attitude and an orientation of a camera. They include geographic positioning systems, inertial sensors, accelerometers, gyroscopes, magnetometers, proximity sensors for localization and the like. Extremely high performance inertial sensors and MEMS are marketed, for instance by Gladiator Technologies of Snoqualmie, WA and ACEINNA, Inc. of Tewksbury, MA. An overview of MEMS in mobile phones is provided in the article “Analysis of the Accuracy and Usefulness of MEMS Chipsets Embedded in Popular Mobile Phones in Inertial Navigation” by Adam Ciecko et al. 2019 IOP Conf. Ser.: Earth Environ. Sci. 221 012070, which is incorporated herein by reference.

Image stabilization in cameras, either in Optical Image Stabilization (OIS) which is a mechanical system or in Electronic Image Stabilization (EIS) is known. In OIS either a lens system is moved and or rotated or an image sensor is moved or shifted. However, both OIS and EIS work over very limited distances and angles. EIS and OIS address certain forms of hand shake and vibration or jitter. Usually only in x-y direction and only sometimes in rotation or roll. Roll correction over a limited range is sometimes addressed by controlled image sensor shift. A description of camera shake/jitter and how to address it with OIS is provided in La Rosa et al. Optical Image Stabilization (OIS) from STMicroelectronics and downloaded from https://www.st.com/content/ccc/resource/technical/document/white_paper/c9/a6/fd/e4/e6/4 e/48/60/ois_white_paper.pdf/files/ois_white_paper.pdf/jcr: content/translations/en.ois_white paper.pdf which is incorporated herein by reference. FIG. 8 of the above document illustrates the common magnitude of the shake jitter effect which is mostly below 0.5 degree and almost never greater than 2 degrees. Systems that deal with correction of these magnitudes are unable to handle anything greater than 2 degrees deviation, which is the purpose of aspects of the current invention. In fact, the structures as provided herein allow for tracking a point in space or an object by a camera wherein the camera deviates over 5 degrees from a pointing direction to a static point while and generates a stable image of that point. Thus the provided system is not a stabilization system but rather a digital gimbal equivalent to a mechanical gimbal for imaging devices as known in the art.

The terms “digital gimbal” and “e-gimbal” are used herein, to indicate an absence of moving or motorized mechanical components as in standard gimbals. The term “digital gimbal” itself is not new, even though the inventive concepts and the embodiments of the present invention are. A recent article by Dahary et al. Digital Gimbal: End-to-end Deep Image Stabilization with Learnable Exposure, 2021 downloaded from https://arxiv.org/pdf/2012.04515.pdf and incorporated herein by reference, teaches a “digital gimbal” but is directed to denoising and deblurring rather than acting as a wide range true gimbal. The “digital gimbal” as provided herein comes at a cost. Not only the cost of processing and sensing, but at a cost of “image waste.” Image waste may range from 30% to over 70% of available image data which will not effectively be used in a displayed image. However, the operational cost of such “image waste” may become negligible after the non-recurring cost of equipment. With low cost in chip based components that are not prone to rapid failure and are small and may be completely hidden inside a body, a “digital gimbal” is a very effective and attractive operational alternative to a mechanical gimbal.

In accordance with an aspect of the present invention data representing a panoramic image or part of a panoramic image is generated by a processor. Using sensors and devices on a smartphone or a camera system, a position (including a geographical position such as a GPS position), a vertical and horizontal orientation and an altitude are determined and recorded.

A system may set a preferred viewing direction, it determines a yaw in a viewing direction from in system chips like IMU sensors. It may determine a preferred position of a stable image as part of a panoramic image, if required using stored pixel to angle relations, computing the required size of a stable image and selecting the necessary pixels from the panoramic image to create a stable image and displaying the stable image in a predefined window.

Most current mechanical gimbal based systems are usually external to a camera system and require carrying extra and separate equipment, while internal mechanical platforms may be sensitive to shock damage and are relatively expensive compared to cheap camera and other chip based components. In accordance with an aspect of the present invention, a hybrid electronic/mechanical system is provided. In accordance with an aspect of the present invention, a plurality of cameras are positioned on a rotatable platform in a camera. That is: a platform that counters rotation or roll of a camera system around its viewing direction. This stabilizes the image relative to a horizon and now requires only yaw and pitch correction, which may take place in a much greater measure and would be more expensive to address. Furthermore a simple system may be applied to counter pitch or yaw. With or without roll compensation, in such a case only one series (either horizontally or vertically) of multiple cameras is required. For instance panoramic images are generally taken over a wide horizontal view. In that case it is beneficial to have a horizontal row of cameras. A movable platform may be used to correct mechanically a pitch of a camera.

The above is useful when it is difficult to stably hold a camera system and because of movement of the camera system an object leaves the field of view of the camera. The above approach keeps the object inside the FOV of the multi-camera and generates a relatively or completely stable image on a screen of predefined size.

A multi-camera system as taught herein may have enabled a preferred recording position or recording pose and extract an image corresponding to that preferred pose even when the center of the system is not pointed in the preferred direction or pose. A user may switch off the system or walk away, with the system active, or may go to a new location. Anyway, a system may activated to recall a preferred location of an object, and/or a preferred pose or pointing direction of the camera system. A processor of the system may determine new coordinates of a system's location and based on the previous location and/or pose and/or a known or estimated position of the object determine one or both of 1) the required pose of the camera system to capture the object in the new location; 2) if a current pose of the camera system places the desired object within a field of view of the camera system and 3) provides guidance, for instance with visual markers on a screen, how to move the camera system to place the object within the field of view of the camera system. In one embodiment of the present invention an object may have a GPS or location device that provides location coordinates, including an altitude to the camera system, preferably through a wireless connection. This enable a camera system as disclosed herein to compute a pose that places the object in it field of view. It is not needed to center the camera system on the object. A marker, like a circle or a rectangle or other icon or shape, may change color indicating if an object is inside a field of view. For instance a shape like a rectangle may be red when an object is outside a field of view, turn orange when closer to field of view but still outside, blue turning green when the object is inside a field of view and is moved to a center. This approach is beneficial when an object's location is known but for some reason not visible, obscured by another object, hard to recognize because of size, or is lost for recognition in a plurality of objects.

This illustrates how with a panoramic active area image sensor construction and a calibration method one may reconstruct the correct image of an object on a screen smaller than the total panoramic image. As long one keeps an object sufficiently within a field of view of the panoramic camera, one may reconstruct a smaller but correct image of an object even with substantial movement of the camera system. One is reminded that image overlap is just that, image overlap. Not sensor overlap.

Step-by-step approach Collection of roll corrections: Interpolation: for small roll angles (e.g., 0.01 to 2 degrees), simple interpolation methods may be used to adjust the image with minimal computational load. Scanline Jumps: For moderate roll angles (e.g., 2 to 5 degrees), one may use scanline jumps, such as moving 1 pixel up for every 5 pixels horizontally. Homographies: For larger roll angles (e.g., 5 to 10 degrees), apply homography transformations every few frames (e.g., every 5 frames) to create a new baseline. Labeling best approaches: Label each correction method for specific roll angles, creating a comprehensive dataset that covers angles from 0.01 to 10 degrees in incremental steps. Training a CNN: Train a Convolutional Neural Network (CNN) on the labeled data. The CNN will learn to select the best correction method for each roll angle based on the training data. The CNN can be designed to operate in real-time, making quick decisions on the appropriate correction method. Using GPUs: If GPUs are available, leverage their parallel processing capabilities to handle the computational load of homographies and other complex transformations. GPUs can significantly speed up the processing, allowing for real-time stabilization even for larger roll angles. One may rely on the trained CNN to manage the roll stabilization. Implement a strategy to lower the frame rate when the rotation angle is too large, reducing the computational load and ensuring smooth performance. Adaptive Frame Rate: When approaching a roll angle that supersedes a threshold, lowering the frame rate during large rotations can help manage the computational load without sacrificing too much video quality.

Applying artificial neural networks in image stabilization in combination with IMU sensors is known. For instance U.S. patent application Ser. No. 16/120,037 filed on 31 Aug. 2018 to Kang et al., published on Mar. 5, 2020 and which is incorporated herein by reference teaches machine-learning using inputs from IMU sensors and applying a neural network to predict counteracting motions. Similarly, U.S. patent application Ser. No. 18/256,587 to Shi et al. PCT filed on Dec. 10, 2020 which is incorporated herein by reference teaches a Deep Neural Network to learn rotation and translation of a camera and to provide correcting warping.

For roll correction one may distinguish the following situations. In one example a center or neutral point that determines a pointing direction of the camera system is pointed at an object or scene and a menu item or button on the camera system is activated, thus setting the pose of the camera system as determined by inertial sensors, and/or compass, and/or GPS and others that are available as the instant starting direction. The positional sensors then determine any rotation (roll, pan, pitch) of the camera relative to the initial pose or pointing direction. The processor then finds a point in the extended image space (which is now possibly roll rotated) that conforms with a translation equivalent to a panning and pitching angle being the negative or inverse direction of the measured pan and pitch. This is equivalent center point and a window which may be rectangular, equivalent to a size of a to be displayed may be applied to rotate back equivalent to the roll angle, creating image data of the scene or object. This captures an image that is substantially stable of a static scene, with a moving or rotating camera that includes roll. When the camera system itself is moving in a translation, the processor may compute an updated neutral pointing direction. This process may be simplified by using the camera system in different positions and using for instance the included GPS to determine by triangulation the GPS position of the object or scene. This allows the processor to update the neutral pointing direction towards the object or scene and use the updated neutral pointing direction for the steps as provided herein.

An advantage of the above e-gimbal approach is that there needs not to be a detectable object at the pointing direction, as the set (and updated) pointing direction and the measured rotation angles determine the e-gimbal window.

Furthermore, one does not require to un-roll the entire extended image space. Based on measured rotation angles one may compute a center of a desired window in rotated form, define a rotated window that after un-rotation has a desired display size and only un-roll the image data in the rotated window.

In yet another embodiment of the present invention. as explained herein, an object is detected and tracked in the extended image space. A center of a detected and tracked object may be mapped to an (x,y) coordinate in the expended image space and a pre-defined sized window may capture the image data inside the pre-set window. With detected roll, the window size is defined as being corrected for roll. To illustrate this, assume that the camera viewing a horizon has roll of 10 degrees clockwise viewing in the direction of the horizon. That means that the actual image when viewed in standard mode shows a horizon that has an upward angle of 10 degrees. Thus one needs to construct a rectangular window that is preferably slightly bigger than the display picture with sides parallel (and perpendicular) to the horizon and create a homography of a 10 degrees downward to create a correct “roll corrected” image. This method has as advantage that as long as the object is tracked within the field-of-view of the camera system, an (x,y) position of the center of the object may be determined and the required steps include creating a window size to capture the image data and use the sensor measured roll to correct roll.

The required pointing direction in one embodiment is an initially set pointing direction, determined for instance by centering a camera on an object or space and recording the pointing direction or pose as the required pointing direction. In such a case a required pointing direction is invariant until it is changed. In one different embodiment a pointing direction is determined and for instance computed from actual coordinates of a space or object. In that case, when the camera system moves, the coordinates of the object may remain constant and based on actual positions of the camera system, the required pointing directed is recalculated, for instance at regular intervals. In yet a further embodiment an object may be moving that is being recorded by a panoramic camera system. Also in that case an actual pointing direction has to be recomputed. There are several ways to recalculate the required pointing direction. For instance an object tracking application may be applied. At the beginning of an image recording, an object is centered on the camera system, the actual position of the object is determined as well as the required pointing direction. The object is tracked in the image space of active areas of the image sensors. The object image may be found with its center. The image may be extracted and displayed on a screen. A reverse determination of actual position relative using the calibration may be applied. This provides a deviation of an actual pointing direction of the camera system and hence a processor can determine an actual deviation in rotation angle based on the movement of the object. In a further embodiment a user may hold the camera system in a constant pose, while the system tracks and displays the object. A processor may estimate, based on rotation speed, a future position of a moving object, making image location in image space more predictable for a processor.

One form of tracking is to center the camera on an object and move with or around the object. Object tracking in an image is well understood and enabled. Image tracking may be done for instance with the earlier recited OpenCV software or with commercially available tracking software. The software finds in the image the tracked object and its location in the image and extracts a displayable image of a predefined window size from the total multi-camera image to be displayed on a screen.

In accordance with an aspect of the present invention, the extracted image may be of a size slightly bigger than the displayed image. The excess pixels may be used to apply EIS to the extracted image. Again OpenCV or other software may be applied to stabilize an extracted image. Similarly, in forming the extended image space or panoramic image one may store or sample image data in overlap regions that would be ignored or deleted in the actual contiguous panoramic image. This extra data may be used in quality control and adjustment, such as detection of active area borders, image intensity blending and the like.

In accordance with an aspect of the present invention a local position and pose of a camera system is recorded. Also, coordinates, estimated, computed or otherwise obtained from a space or object that is associated with the coordinate system location and pose may be retrievably be stored in a memory. A camera system records an image of the object or space. It may be that through movement of the camera or otherwise the object is not in the center of capture of the camera-system. As explained earlier herein, actual coordinates of the object are available and are stored or may be computed and stored on the system. A user may switch off the system or move the camera system while not being directed at or with the object in a field-of-view of the camera system. A user may actually leave the area of recording with the camera system and come back later in the same area, but not necessarily in the same spot, to continue recording of the object or space as determined and stored previously. The camera system may be activated and the location/coordinates of the object may be recalled. Based on actual current location coordinates, including an altitude, the camera system may compute, using known geodesic geometric computations, the required pose of the camera system to direct a center of the camera system at the retrieved coordinates of the object. A display on a screen of the camera system may guide a user to point the camera system in the required pointing direction. For instance by displaying arrows on a screen and showing an appropriate icon an the screen when the camera system is appropriately positioned and directed. This approach allows a camera to be correctly pointed by a user at the same object even when the camera system has been moved.

An image sensor is associated with a lens. A lens may be combined with a sensor in a housing. The combination of a lens with its associated sensor is called a lens/sensor unit. A lens in one embodiment of the present invention is a fixed focus lens. In a further embodiment of the present invention a lens has a focus mechanism. A focus mechanism can be a manual focus mechanism, for instance by rotating the lens. In yet a further embodiment of the present invention, a lens has an auto-focus mechanism.

The following 5 patent applications describe aspects of image alignment and calibration for stereoscopic and 3D images and are incorporated by reference herein in their entirety: U.S. patent application Ser. No. 12/435,624 filed on May 5, 2009, U.S. patent application Ser. No. 12/436,874, filed on May 7, 2009, U.S. patent application Ser. No. 12/538,401 filed on Aug. 10, 2009, U.S. patent application Ser. No. 12/634,058 filed on Dec. 9, 2009 and U.S. Provisional Patent Application 61/291,861 filed on Jan. 1, 2010.

Camera components such as controller for instance for controlling lens focus, lens aperture and shutter speed, memories, sensor data and image processor are connected internally for instance by a data bus. Such structures are known to one of ordinary skill in the art and are not shown in the figures to prevent obscuring the aspects of the present invention with known matter. Details of an internal processing and communication architecture of a digital camera is disclosed in for instance U.S. Pat. No. 7,676,150 to Nakashima issued on Mar. 9, 2010 and U.S. Pat. No. 7,667,765 to Turley et al. issued on Feb. 23, 2010 which are both incorporated herein by reference.

In a further embodiment of the present invention control of a camera is provided to the computing device such as cell phone. In yet a further embodiment of the present invention the computing device can open at least one menu on the display screen of the computing device that enables control of the separate camera. This allows a user to be part of an image taken by the camera while retaining control of the camera. In one embodiment of the present invention the display and camera are physically separate and are connected through a wired connection. In a further embodiment of the present invention the display and camera are physically separate and are connected through a wireless connection.

In one embodiment of the present invention the e-gimbal is used in a POV (point of view) camera, or point-of-view camera, is a camera that captures footage from a person's perspective, often attached to their body or head. These cameras are designed to provide a first-person view, immersing the viewer in the scene as if they were experiencing it themselves. They are commonly used in action sports and/or for recording step-by-step instructions. As an example a POV camera is used in recording glassblowing an object. An intent is to keep a camera focus on a hot glass object on a blow-pipe or a punty. However, for instance safety requirements necessitates a glassblower to establish situational awareness and move their head or body. This causes the camera to move a center of attention away from an instruction piece. In one embodiment of the present invention a multi-camera e-gimbal system is part of a POV camera. In yet another embodiment of the present invention, a multi-camera e-gimbal is incorporated in what may be called Glass, Smart Camera Glass, or Spectacles. It is a known computer system incorporated in a spectacles frame with one or more cameras incorporated in the spectacles frame.

In a further embodiment of the present invention one or more sensors such as accelerometers are attached or part of a system. A system with accelerometers is disclosed in U.S. Pat. No. 7,688,306 to Wehrenberg et al. issued on Mar. 30, 2010 which is incorporated herein by reference. The purpose of the sensors is to determine a position or a change of position of the display. Based on the detected change in position a signal which is associated with the difference of position of the display is generated and is used to control or drive a motor or an actuator in the platform. Positional sensors and positional difference sensors are known and include accelerometers, magnetic sensors, MEMS with mechanical components, gyroscopes such as optical fiber gyroscopes, Hall sensors, inertial sensors, vibrational sensors and any other sensor that can be applied to determine a positional or angular difference or angular rate change or angular velocity or a linear rate change or linear velocity change of the display. These sensors will be called a positional sensor herein. Many of these positional sensors are available in very small formats, for instance integrated on one or more chips, which can easily be fitted inside a body of a system.

It is to be understood that supporting structures, connectors, bearings, power sources, buses and all other materials required to make the design operational may be assumed even though not shown as to prevent overcrowding the drawing and obscuring the intended design. For instance cameras show no further details or connectors, processor, memories and controls. This is not because they are ignored and thus the devices are not hanging in a structure without context and are expressly not intended to be without context and/or connections. Again, all necessary structures and devices may be assumed and will be recognized to be included by a person of ordinary skill.

A processing unit herein is a chip or a plurality of chips that are enabled to execute processing instructions such as known in the art of processing and computer machines. Processing of an instruction includes retrieving and enabling of a processing instruction such as adding a content of a memory to a content of a register, for instance. These are ultimately physical operations. A processing unit may be a processor such as a microprocessor, a core of a multi-core processor, a dedicated co-processor such as a Graphics Processing Unit (GPU), a customized processor such as a Field Programmable Gate Array, a computer, or any device that may be identified as a processor and that is enable to execute instructions. Instructions and/or data may be retrieved from separate or common memory and stored in local memory. The distinction between processor and processing unit is made, because processing cores in a multi-core processing may not always be recognized as a separate processor. A processing unit therefore herein is a device with physical structure, commonly including one or more electronic chips or chip area.

Positional and inertial sensors, 3-dimensional geometry, projective geometry and for instance RANSAC software as is known in the art are used to enable the positioning and computations. Determining of a pointing direction is disclosed in for instance U.S. Pat. No. 7,741,961 to Rafii et al. issued on Jun. 22, 2010 and U.S. Ser. No. 13/058,962 to Garcia et al. filed on May 6, 2011 which are incorporated herein by reference.

In one embodiment of the present invention, the camera system is part of a surveillance camera that is fixedly or removably attached to an object or a structure, including a building, a vehicle, a drone, a post, a fence, a person, an animal or any other fixed or moving object that can hold the camera device. In generally existing surveillance cameras are attached to external motors to pan an area. The surveillance camera can be fixed to a structure.

A computing device herein is a device with a housing with a processor enabled and configured to retrieve instructions from a memory, to execute instructions to perform steps that can be represented as programming steps as in Matlab, C#, Java, Python and the like. The instructions may process data retrieved from memory or provided via input devices such as keypad, touchpad, mouse, camera, sensors, a microphone, a communication channel and the like which are part of the device. The computing device connects to a communication channel, which may be a network connection, via communication circuitry, which may be wired or wireless oriented equipment. A display screen may be included for input and output purposes and a loudspeaker or at least an audio output and image and audio circuitry. Output may be provided on an output channel. Certain sensors such as accelerometers, a gyroscope and a digital compass as well as GPS circuitry may be included. An antenna may be included as well as a power supply. An example of a computing device is a smartphone, a tablet, a laptop and a desktop computer.

To establish a panoramic image from image data only generated by image sensor elements in active areas of image sensors herein means that the image data only generated by and only harvested from active areas are stored in a retrievable way as a single substantially panoramic image or proto-image. A substantially panoramic image or proto image is wherein no or almost no overlap data is included. A proto-image is image data that may require additional processing like demosaicing or color correction or warping. Initially one may apply available stitching software to determine a stitching line between two calibration images. An image sensor map may map pixels in an image to the physical pixel elements on an image sensor. This allows to determine a physical merge line that determines an active area of an image sensor and creates a panoramic proto-image or panoramic image representation in memory when for instance harvested image data from active areas are stored in a contiguous and retrievable way on a memory which may be called image memory.

As explained before, while the harvested data from active areas already represent or substantially represent a panoramic image, additional processing may be needed to optimize the image data for viewing. This may include color correction and/or gray scale correction. Doing color correction in real-time is known and is for instance disclosed in Sigurd Ljodal Master's Thesis 2014, Implementation of a real-time distributed video processing pipeline, downloaded from https://core.ac.uk/download/pdf/30903173.pdf which is incorporated herein by reference. Similarly Espen Oldeide Helgedagsrud in Master's Thesis Efficient implementation and processing of a real-time panorama video pipeline with emphasis on dynamic stitching downloaded from https://www.duo.uio.no/bitstream/handle/10852/37683/Helgedagsrud-master.pdf?sequence=2&isAllowed=y discloses which is incorporated herein by reference, teaches real-tine color correction. Fast operations are achieved by parallel operations by for instance dedicated GPU processors. In accordance with an aspect of the present invention, color correction requirements may be determined in a calibration step prior to real-time operation. That is: required transformation matrices are computed based on stored calibration and/or actual conditions. Optimal correction may be estimated and computed prior to real-time recording. Because no additional determination and expensive estimations may be required and correction is a simple execution of previously stored parameters. The above solutions are part of the Bagadus System: Bagadus: An Integrated Real-Time System for Soccer Analytics, HAKON KVALE STENSLAND et al. 2014, downloaded from DOI: http://dx.doi.org/10.1145/2541011 which is incorporated herein by reference.

In accordance with an aspect of the present invention each camera may experience distortion, such as barrel lens distortion. There are commercial products available that correct in real-time image distortion. One possible approach is to determine a required distortion correction (which usually is a geometric distortion, such as straight lines) which may be corrected by pre-determined image warping. This is explained for instance in Mattoccia et al, Real-Time Image Distortion Correction: Analysis and Evaluation of FPGA-Compatible Algorithms, 2916 downloaded from https://arxiv.org/pdf/1610.09712.pdf which is incorporated herein by reference. Another example of real-time image distortion correction is: Van der Jeught S, Buytaert J N, Dirckx JJ; Real-time geometric lens distortion correction using a graphics processing unit. Opt. Eng. 0001; 51(2): 027002-1-027002-5. doi: 10.1117/1.OE.51.2.027002, which is incorporated herein by reference.

All corrections may be predetermined and related matrices and/or parameters may be stored in memory for appropriate retrieval, for instance after a calibration check by a processor and implemented in parallel for instance on GPUs or FPGAs for at least each camera. The immediate execution of the software and circumventing a necessity to first apply a processing time expensive of determining or estimating required parameters creates a very fast processing system that may be include several parallel video pipelines. The result is a high quality video image generated in real-time which may be used in accordance with one or more aspects of the present invention as a digital gimbal to generate a (smaller) stable image of a scene from a panoramic image. The cost of relative cheap processing power that continues to diminish in cost while increasing in power, allows the use of 2 or more relatively inexpensive but high quality cameras, instead of using expensive lens wide view cameras and expensive and more failure prone mechanical solutions.

As discussed above a composite panoramic image, also called an extended image space, may be formed from images generated by multiple cameras in a single housing. From the extended image space a smaller stable window, called a gimbal window or e-gimbal window or e-gimbal, is created and may be displayed on a display/screen representing a stabilized image, with may be a video image. The inventor has checked the USPTO Trademark database. The name e-gimbal is not a registered trademark. The term ‘egimbal’ was trademarked but has been abandoned. Thus the name e-gimbal, which is short for digital gimbal or electronic gimbal, is currently at the time of submission not a trademark and is believed not to conflict with any private ownership and is believed not to require permission of use. However, the term e-gimbal herein is intended to mean “digital gimbal” as opposed to the known “mechanical gimbal” which applies motors or mechanical actuators.

Mechanical gimbals are well studied and an abundance of literature exists on classical (PID) gimbal controllers. One overview is provided by the thesis: Thinh Huynh, A Study on Motion Control of Gimbal-based Target Tracking System, February 2022, Pukyong National University, downloaded from https://repository.pknu.ac.kr: 8443/bitstream/2021.oak/24416/2/A % 20Study %20on%20Motion %20Control%20of%20Gimbal-based%20Target%20Tracking%20System.pdf which is incorporated herein by reference.

A further explanation of good object tracking applications is provided on website https://www.oxagile.com/article/tracking-live-video-objects-with-a-moving-camera/by Oxagile Corporation of New York, NY, which is incorporated herein by reference. Herein KCF—Kernelized Correlation Filter came out as a very usable tracking application. One may use the KCF application to determine a position of an object and apply the determined position as a neutral of focus position of the mechanical gimbal. Other tracking applications are known and its application is fully contemplated.

In accordance with an aspect of the present invention a size of an e-gimbal window may be pre-set, for instance at the size to fill a screen on a camera. In accordance with a further aspect of the present invention, a user may select pre-set e-gimbal window sizes, for instance from a menu of a screen of the camera system. In accordance with a further aspect of the present invention, a user may set the dimensions of an e-gimbal window as a customized e-gimbal window.

A more recent development is the use of neural networks in image stabilization, particularly convolutional neural networks. One such approach is described in Liu et al, Deep-Learning Image Stabilization for Adaptive Optics Ophthalmoscopy, Information 2022, 13, 531. https://doi.org/10.3390/info13110531, which is incorporated herein by reference. Another good article is Lee et al, 3D Video Stabilization with Depth Estimation by CNN-based Optimization, 2021, downloaded from https://openaccess.thecvf.com/content/CVPR2021/papers/Lee_3D_Video_Stabilization_With_D epth_Estimation_by_CNN-Based_Optimization_CVPR_2021_paper.pdf which is incorporated herein by reference. One approach is to use a Convolutional Neural Network (CNN) architecture for supervised learning. One may use a number of different training inputs of frames of jittery video images as well as the optical flow of stabilized frames of the previous video stream and train the CNN by a loss function that optimizes the error between the input and output.

Neural networks may be applied for other image processing functions, such as fine-tuning image alignment, color-correction, image blending, image warping for instance for distortion correction and the like. This is beneficial in situations where the multi-camera system includes 2 or more cameras that are well known and potentially identical. This means that camera parameters and active areas and other parameters are identical or almost identical and controlled within narrowly defined tolerances. This means that all neural network training may be done on almost unlimited number of inputs and training cycles and may be implemented in 100s, 1000s or even millions of identical implementations for control purposes. Thus individual cameras do not have to be individually trained.

In fact practical AI Image Stabilization applications are available from different companies such as VIDIO from MOSAIK Studio, Inc. of Orlando FL and described on www.vidio.ai which is incorporated herein by reference.

Thus one is now enabled to create a very stable video image on a predefined size window or display of a moving camera, preferably using a moving camera with an extended image space as taught herein. This is especially useful for portable consumer cameras, such as used in smartphones and/or tablet computers or other camera devices for instance on a flying or flyable drone. This creates a stable focus on a static object or point in a scene as an e-gimbal.

In accordance with an aspect of the present invention, a processor is programmed to track a moving object. For instance a Kernelized Correlation Filter (KCF) approach is known in the field of computer vision to provide reliable object tracking as described for instance in Hagui et al. A Comparison of OpenCV Algorithms for Human Tracking with a Moving Perspective Camera, EUVIP2021—9th European Workshop on Visual Information Processing, June 2021, Paris (virtuel), France. ff10.1109/EUVIP50544.2021.9483957ff. ffhal-03248524f which is incorporated herein by reference. But rather than strictly image/object tracking the KCF or other object tracking image software is used differently. Either through systematic mapping, geometric mapping or supervised neural network learning, the extended image space of the cameras system is mapped into angles of rotations relative to a pre-defined center of the extended image space. For instance take the center of window 2602 in FIG. 7 as neutral center of the extended image space. And an object inside window 2602 then would have rotations θpan=0 and θpitch=0, assuming that the image space has been corrected for roll. This means also that the object being detected/tracked in window 2607 would be associated with θpan=most_left and θpitch=most_down, which are angles determined empirically during training, calibration or other mapping. This means that when a moving object recorded with a moving camera is within the extended image space, its actual position relative to a center may be determined.

Both NPX and Texas Instruments for instance have launched extremely powerful digital signal processors while dedicated Neural Processing Units (NPUs) are being developed. Thus, an e-gimbal, while computationally fully enabled, may for mass consumer purposes be implemented with only base capabilities. However, it seems that a fully functional e-gimbal with highest resolution images may be implemented on an affordable scale to work real-time on a consumer smartphone within 4 or 5 years after writing this.

Camera calibration may be performed with a camera capturing a known image, usually a chessboard-like image. Current application such as Matlab and OpenCV then may be applied to undistort what are generally called the intrinsic distortions of the camera. This is for instance taught in https://docs.opencv.org/4.x/dc/dbb/tutorial_py_calibration.html which is incorporated herein by reference. One may apply the undistort to each of the individual cameras. Keeping in mind that all individual cameras are practically identical in a multi-camera system herein. This allows for a highly parallelized computation approach with separate processors or processor cores performing the correction. OpenCV can execute undistortion well in real-time. The undistortion of the calibrated active areas of image sensors and combined in memory, establishes a large homogeneous extended image space, larger than an image space of an individual camera.

In a next step one needs to match a pointing direction of the camera system of multiple camera with a coordinate (x,y) point in extended image space. This is also known in image processing and is known as image projection for instance as explained in on-line document https://www.cs.cmu.edu/˜16385/s17/Slides/11.1_Camera_matrix.pdf as lecture from CMU School of Computer Science and Lecture 12: Camera Projection published by Penn State University at https://www.cse.psu.edu/˜rtc12/CSE486/lecture12.pdf which are both incorporated herein by reference, and should be well established knowledge for someone with ordinary skill in the art of computer vision. One may then find the rotation matrices that project a known point in physical space to an (x,y) point in image space. In Matlab one may use the ‘estworldpose’ to determine or estimate the camera pose. A more elaborate approach, but much faster in execution, is to associate a neutral position (like the center CTR of a camera) with the center position of the image. One then steps the camera through panning, and pitch and if desired roll, rotations and associate the rotation with measured (x,y) positions, By taking sufficiently large steps one may use linear interpolation to determine intermediate position. Such a conversion from rotation to coordinates circumvents potentially expensive rotation matrix calculations. In a multi-camera system one may determine the conversion for just one camera and use the conversion for all cameras appropriately as presumably all cameras are identical.

Image processing and computer vision are currently still mainly procedurally deterministic processes and rather computational intensive, with a need to carefully tune boundary effects. The use of deep learning or neural network of computer vision procedure is coming in its own right now and is a realistic and attractive alternative to programmed computer vision. A downside may be the need to train the neural network, to find the correct layer sizes, to find a correct loss function, to correctly label training data in supervised learning and the time it requires to train a neural network. However, a great benefit, when done correctly, is a training in a broad array of different conditions, the use of dedicated neural network processors or NPUs, and the speed of execution. The execution of a trained neural network is orders of magnitude faster than the training requirements and may be at least an order of magnitude faster than standard image processing programs. Some of the following image processing/computer vision neural network tools are available that can train neural network for steps as provided above in accordance with one or more aspects of the present invention. TensorFlow and KerasCV as disclosed in https://www.tensorflow.org/tutorials/images and pages it points to is incorporated herein by reference is a deep learning computer vision toolbox that implements steps of the e-gimbal as disclosed as one or more aspects of the present invention. Pytorch is another powerful neural network based toolbox.

Camera calibration and undistortion by neural networks is disclosed in Bogdan et al., DeepCalib: A Deep Learning Approach for Automatic Intrinsic

Calibration of Wide Field-of-View Cameras, CVMP '18, Dec. 13-14, 2018, London, United Kingdom, https://doi.org/10.1145/3278471.3278479, which is incorporated herein by reference. The article is accompanied by github available software implementation available from https://github.com/alexvbogdan/DeepCalib which is also incorporated herein by reference.

Estimating a camera pose with neural networks is disclosed in Shavit et al. Introduction to Camera Pose Estimation with Deep Learning, downloaded from https://arxiv.org/pdf/1907.05272 which is incorporated herein by reference. In practice a much simpler way is to apply supervised learning on a neural network by stepping through known camera rotations and labeling correct positions in the image space.

A purpose of the above is to allow one of ordinary skill in CNN programming, Python, TensorFlow and OpenCV applications to build the required CNN for mapping of physical camera angles to extended image space of a multi-camera system as disclosed herein above. One may add in a similar fashion also pitch angle transformation. And if required roll conversion. By object tracking in which one may also a CNN Model like KCF, the tracked position of an object may be converter to a coordinate position in image space. One may pre-define a size of a display window around a determined angle, to create a desired e-gimbal window. The use of neural networks may facilitate real-time execution. Multi-core CPUs, Graphic Processing Units (GPU), Neural Processing Units (NPUs) and Tensor Processing Units (TPUs) individually or in combination combined with a highly parallel architecture, may enable very fast real-time processing of the e-gimbal, and potentially an order of magnitude fast that deterministic implementations, which are also fully enabled herein.

It is assumed that neural networks and convolutional neural network as well as computer implementations using applications like TensorFlow and Pytorch are nowadays mainstream and known technologies and no detailed explanations are required for one of ordinary skill in the art of advanced image processing and computer vision technology. For convenience one may refresh knowledge of CNNs for instance by webpages https://victorzhou.com/blog/intro-to-cnns-part-1/and https://victorzhou.com/blog/intro-to-cnns-part-2/which enables one of ordinary skill to implement a computer vision CNN and which are incorporated herein by reference.

It is assumed that neural network technologies and more specifically convolutional neural networks (CNNs) are nowadays part of known technology in image processing and computer vision. For reader convenience to refresh knowledge on CNNs one is referred to https://victorzhou.com/blog/intro-to-cnns-part-1/and https://victorzhou.com/blog/intro-to-cnns-part-2/which are both incorporated by reference herein. Required instructions to invoke and implement CNNs are for instance part of the Pytorch and TensorFlow applications.

As disclosed herein an e-gimbal may be implemented in different ways wherein different conditions may play a role in selecting a preferred way to implement and/or apply a specific e-gimbal to create an image which is preferably a video image of a scene and/or object with a camera that may be moving of a scene or object that is static or is also moving. An e-gimbal system may be implemented using one or more neural networks, which preferably are Convolutional Neural Networks (CNNs). One may implement an e-gimbal system that ignores camera roll and/or keep the camera system stable against roll. E-gimbal implementation correcting camera roll also have been disclosed herein. In one embodiment of the present invention one may perform all instructions in real-time on the cameras system. This may require installing and using multiple computer processing units that may work in parallel fashioned and/or pipelined or work separately on sections of an image space, the processed sections to be recombined in a single e-gimbal window for display. The above also indicates that “a processor” herein is specifically means one or more processors, wherein a processor may mean a separately packaged device or part of a device such as a processor core as is known in computer technology. A processor also may be a GPU or NTU or TPU or dedicated customized processing circuitry such as FPGAs (Field Programmable Gate Arrays) or other customized processing circuitry. The difference between these processor types is described in website https://www.backblaze.com/blog/ai-101-gpu-vs-tpu-vs-npu/which is incorporated herein by reference.

In accordance with an aspect of the present invention one postpones demosaicing steps in the different set of processing steps until after image calibration and combining. This leverages the raw sensor data to preserve fidelity and reduce compounded artifacts. Preserving native signal: raw data retains the original sensor readings, which are untouched by interpolation. This gives a clean input for calibration, alignment, and stitching. It avoids early artifacts: demosaicing can introduce edge artifacts, color fringing, and false textures especially in high-frequency regions. Demosaicing too early, may bake in imperfections into every downstream process. It improves calibration accuracy: lens distortion correction, exposure matching, and geometric alignment are more precise when applied to raw data, since a processor is working with the actual sensor values. Once an image has been stitched and aligned in raw format, demosaicing can act as a final pass to smooth out residual inconsistencies-almost like a finishing polish. Thus, it provides a combined method for panoramic image generation comprising: capturing raw image data from a plurality of image sensors; performing image calibration, alignment, and combination on the raw data; and applying demosaicing only after the combination, wherein the delayed demosaicing step reduces interpolation artifacts and enhances final image quality. This creates a system that is sensor-aware, artifact-resilient, and computationally efficient.

A further slightly embodiment for RL for Bounding Box Tracking is provided. A goal is to train an RL agent to select or update the center of the bounding box in extended image space over time, based on observations from the scene and feedback from a reward signal. A RL setup includes a state observation and processes the current extended image space frame, a previous bounding box center, IMU data (optional). CNN prediction (optional input to the agent). An action may be: move bounding box center: (Δx,Δy) Or directly select new center: (xt,yt). Process a reward: high reward for accurate tracking: high IoU with ground truth, low perceptual loss (e.g., LPIPS), high SSIM with stitched composite and penalty for drift, jitter, or occlusion. A training loop is executed, for instance using prepared or generated ground truth scenes. Benefits of RL may be static object detection, temporal tracking, real-time decision making. RL has further a benefit for adaptive behavior and may be used to tune against components drift, for instance. RL algorithm options may include DON for discrete actions such as grid movement, PPO for continuous actions, SAX for high dimensional control and A3C for parallel training. In yet a further embodiment one may use a CNN or RNN to detect an initial bounding box and a Kalman filter for a smooth motion and an RL agent to learn an optimal movement over time. One may use attention maps to guide RL agent's focus, train RL agent to select scanlines for efficient data harvesting, and use multi-agent RL for coordinating multiple cameras

Hybrid tracking: CNN+Kalman filter to track the center of a bounding box in extended image space as the object or camera moves, using: CNN for visual detection or correction and Kalman filter for temporal prediction and smoothing. A step-by-step architecture may include a CNN Inference (per frame) with Input: Extended image space frame and output: estimated center position (xtCNN,ytCNN). This provides at least a raw measurement of the object's position. Kalman filter prediction predict next center position (xt+1KF,yt+1KF) based on previous state and motion model. Kalman filter maintains state vector: position and velocity, covariance matrix: uncertainty and transition model: e.g., constant velocity or acceleration. In a fusion step one may use CNN output as the measurement update in the Kalman filter. The Kalman filter blends its prediction with CNN's measurement based on uncertainty. This may result in a smoothed, robust estimate of the bounding box center. In advanced variants one may use an Extended Kalman Filter (EKF): If motion model is nonlinear; Unscented Kalman Filter (UKF): Better for complex dynamics; Particle Filter: If one wants to track multiple hypotheses or non-Gaussian distributions; and CNN+LSTM+Kalman: Use LSTM to model temporal features, then fuse with KF. Training for CNN may include train on synthetic scenes with known center positions, Include motion blur, occlusion, and lighting variation, and Use Kalman-filtered ground truth as a target to reduce noise in training labels.

One may apply a calibration-driven bounding box tracking system, by training a calibration map. This is an efficient approach, especially when bounding box dimensions remain fixed and only the position changes over time. Assumptions include initial bounding box is defined around a known point (e.g., center of extended image space), Bounding box size and shape are fixed, Only the center position changes as the object or camera moves, one wants to track the new center and compute the updated corners. In an algorithmic approach (lightweight & deterministic) Step-by-Step: 1. Define Initial bounding box with center: (x0,y0), width: w, height: h, Corners: (x0±w/2,y0±th/2). 2 Track new center: Use IMU, image tracking (KCF, YOLO), or optical flow to estimate new center (xt,yt). 3 Update corners: apply same width/height to compute new corners: Top-left: (xt−w/2,yt−h/2), Bottom-right: (xt+w/2,yt+h/2). 4. Map to image sensors. Use known camera projection matrices to translate bounding box coordinates to each sensor's local space. This approach is fast, interpretable, and works well when motion is smooth and predictable.

One may also apply a Machine Learning (ML) approach: Learn the calibration map. This is useful If motion is nonlinear, noisy, or affected by occlusion. and if one wants to generalize across different camera setups or object types. A training strategy may include: input: scene image or sensor data+initial bounding box parameters, output: new center position (xt,yt), and model: lightweight CNN or regression network. Provide a Loss Function. One may also train a model to directly output the updated corners.

A hybrid strategy with calibration map+ML refinement. Use algorithmic method for initial bounding box translation. Train a model to refine the predicted center based on scene context. Fuse predictions using weighted averaging or confidence scores.

Visualization of calibration map. imagine a grid overlay on the extended image space: each grid cell corresponds to a possible center position. For each cell, one precomputes or learns the corresponding bounding box corners. This can be stored as a lookup table or learned as a function.

One may train a Convolutional Neural Network (CNN) to predict bounding box parameters in the extended image space—and in many cases, this approach can outperform traditional algorithmic methods, especially in complex or noisy environments. The choice between a CNN-based approach and a more algorithmic one depends on goals, constraints, and the nature of data.

A CNN-based bounding box prediction may work very well. CNNs excel at spatial pattern recognition, making them ideal for detecting objects and estimating bounding boxes. Once trained, a CNN can infer bounding box parameters (center, width, height, corners) directly from the extended image space. One may use architectures like: YOLO (You Only Look Once), faster R-CNN: two-stage, more accurate. SSD (Single Shot MultiBox Detector) which provides a balance of speed and precision. Coordinate translation may also be performed. Once the CNN outputs bounding box parameters in the extended image space one may map these coordinates back to the individual image sensors using known geometric transformations: Camera intrinsics and extrinsics, homographies or projection matrices and/or calibration data. This translation is deterministic and can be handled algorithmically post-CNN inference.

A training pipeline for a CNN-based bounding box predictor in extended image space, may use a synthetic scene generator as the data source. This may provide a scalable, automated way to train a model that can infer bounding box parameters (center, corners, width/height) and later translate them to individual image sensor coordinates. A CNN bounding box training pipeline to train a CNN to predict bounding box parameters for objects in the extended image space, using synthetic scenes generated by a PRNG assisted pipeline may include: 1: Synthetic dataset generation using a PRNG scene generator to create labeled training data. Inputs: scene with randomly placed shapes (circles, squares, polygons, etc.), checkerboards. Known object positions and dimensions and associated camera parameters. Outputs: extended image space composite, Ground truth bounding box: (x_center, y_center, width, height) or (x1, y1, x2, y2). One may vary lighting, texture, occlusion, and shape complexity, Include motion blur or simulated camera movement for realism and generate for instance between 1k-100k samples for robust training. 2: CNN architecture using a standard object detection backbone, modified for regression. Suggested architecture: backbone: ResNet-50 or MobileNet (for feature extraction), Head: fully connected layers for bounding box regression Or use YOLO-style anchor boxes if one wants multi-object detection. 3: Loss Function using a combination of localization and shape accuracy. You may also add: IoU loss (intersection over union) and/or GloU or DloU for better spatial alignment. 4: Training loop may include an optimizer: Adam or SGD, a learning rate: Start with 1e−4, Batch size: 32-128, Epochs: 50-100 (early stopping based on validation loss). 5: Evaluation metrics may include IoU score between predicted and ground truth boxes. Mean Absolute Error for center and size and visual inspection: Overlay predicted boxes on extended image space. 6: Coordinate translation once the CNN predicts bounding box in extended image space: Use camera calibration matrices to map bounding box coordinates to each image sensor's local space. Apply inverse projection or homography transformations.

In one embodiment one should incorporate slight bounding box size differences in a rotated camera (roll). In that case a bounding box may be slightly bigger due to the projection of the diagonal of an un-rolled bounding box. The actual display window of the image data is slightly smaller than the bounding box. This is resolved by calculating a fixed size of a display window computed from the stored image data. In a situation of cameras roll, the display window has a fixed size within the bounding box. The display only displays image data determined by the display window which in case of roll may be smaller than the bounding box. Assuming a roll of less than 10 degrees, one may actually pre-set different memory read addresses to display only image data within the display window.

In essence, despite the detailed explanations, the effective execution of aspects of the e-gimbal are quite simple. A bounding box moving through extended image space defines real-time what image data is harvested by the image sensors by programming the scan-line limitations. Thus the harvested image data combined in a video memory represents the required e-gimbal image. Considering the individual image sensors as rectangular grids, one has already determined the base edges of the image sensor active areas of the individual image sensors as illustrated in FIG. 3. These are the base scan-line limitations. So a configuration as shown in FIG. 3 leaves the edge limitations as set and only in real-time sets the rows and columns points as either start or end point for the scan lines. So, as illustration: for image sensor IS 1 the right edge and the bottom edge of the preset scan-line instruction remain the same. IS 1 scanning for the bounding box starts at rows with coordinate x1 and at columns with coordinate y1. For image sensor IS 2, the start column remains the left edge and the end row is the bottom edge. However the start row starts at x2 and the columns end at y2. (wherein x coordinates determines a row and y coordinate a column in a grid of photo diodes.). One may set the rules similarly for IS 4 and IS-5. Image sensors IS-3 and IS-6 don't contribute and are ignored by a control processor. One thus sees immediately that scan-line control is determined by the corner coordinates of a bounding box and its position in extended image space determined by the individual image sensors.

In FIG. 3 and assumption is that the bounding box is about the same size of a single images sensor. That means that at most the bounding box with a 2 rows 3 columns sensor configuration covers 4 image sensors at the same time maximally. One can easily makes a configuration scheme that determines if bounding box corner coordinates determine an end point or a start point of a scan-line. And while analysis and training appear quite involved, execution is blazingly fast and real-time as the system only harvests and processes minimum required data that is mostly processed in parallel by image sensor specific processor, processors, processing core and/or processing cores.

As to the matter of FoV a standard smartphone camera may have (based on lens and also image sensor dimensions) a long axis FoV of about 65 degrees and a perpendicular dimension FoV of 45 degrees, assuming a 24-26 mm focal length lens as in common smartphones. Using 65 degrees as a baseline a 3 camera row of cameras may give a total FoV of 3 times the base. Accounting for overlap and edge avoidance for distortion minimization one may distract about 10% and end with a maximum FoV in one dimension of 195 degrees minus 10% or about 175 degrees. And a smaller max FoV in the other dimension of 135 degrees minis 10% or an effective FoV of about 120 degrees. It is clear that these numbers may change by using different image sensors and lenses and number of camera configurations. However, a system with a configuration as in FIG. 3*2 rows 3 columns of cameras) achieves an impressive FoV of 175 degrees by 120 degrees. As a basis of an e-gimbal, unless extra-ordinary object and/or camera speeds are applied, an object is fairly normal circumstances is unlikely to leave the extended image space of 175 by 120 degrees and stays well inside the limitations of an e-gimbal system.

The following textbooks, tutorials, articles, and documents are incorporated herein by reference in their entirety: (1) Goodfellow, Ian, Bengio, Yoshua, and Courville, Aaron. Deep Learning. MIT Press, 2016; (2) Gollapudi, Sunila. Learn Computer Vision Using OpenCV. Springer, 2019; (3) Cuevas, Erik, and Rodríguez, Alma Nayeli. Image Processing and Machine Learning, Volume 2. CRC Press, 2024; (4) Szeliski, Richard. Computer Vision: Algorithms and Applications, 2nd ed. Springer Nature, 2022; (4) PyTorch Tutorials. https://docs.pytorch.org/tutorials/(5) Princeton University. COS484: PyTorch Tutorial, Fall 2019; (6) Zero to Mastery: Learn PyTorch for Deep Learning. https://www.learnpytorch.io; (8) Kar, Krishnendu. Mastering Computer Vision with TensorFlow 2.X. Packt Publishing, 2020; (9) Martinez, Jesús. TensorFlow 2.0 Computer Vision Cookbook. Packt Publishing, 2021; (10) Takahashi, et al. “Comparison of Vision Transformers and Convolutional Neural Networks in Medical Image Analysis: A Systematic Review.” Journal of Medical Systems, vol. 48, 2024, article 84. https://doi.org/10.1007/s10916-024-02105-8; (11) Ali, et al. “Unveiling the Future: A Comprehensive Review of Machine Learning, Deep Learning, Multi-model Models and Explainable AI in Robotics.” Preprints, 7 Feb. 2025. https://doi.org/10.20944/preprints202502.0369.v1; (12) Codezup. “Real-World Object Tracking with Kalman Filter and OpenCV.” December 2024. https://codezup.com/real-world-object-tracking-kalman-filter-opencv/; (13) Graesser, Laura, and Keng, Wah Loon. Foundations of Deep Reinforcement Learning: Theory and Practice in Python. Addison-Wesley Professional, 2019. (14) Le, Ngan; Rathour, Vidhiwar Singh; Yamazaki, Kashu; Luu, Khoa; Savvides, Marios. “Deep Reinforcement Learning in Computer Vision: A Comprehensive Survey.” Artificial Intelligence Review, vol. 55, 2022, pp. 2733-2819; (15) Jouini, Oumayma, Kaouthar Sethom, Abdallah Namoun, et al. “A Survey of Machine Learning in Edge Computing: Techniques, Frameworks, Applications, Issues, and Research Directions.” Technologies, vol. 12, no. 6, 2024, article 81. DOI: 10.3390/technologies12060081; (16) Devdiscourse. “Machine Learning and Edge AI Drive Industrial Automation to a New Era.” Devdiscourse Technology, 2025. Available at: https://www.devdiscourse.com/article/technology/3531659-machine-learning-and-edge-ai-drive-industrial-automation-to-new-era.

In the event of any conflict between the content of the incorporated references, the later-dated reference shall prevail over an earlier one. In the event of any conflict between the incorporated references and the present disclosure, the content of the present disclosure shall control.

The article ‘a’ herein means one or more, except in the case where one or single is intended and/or explicitly articulated. The above discloses several aspects and/or embodiments of the present invention. This means that several aspects are disclosed related to an e-gimbal. Each aspect may contain an inventive concept and the above is not limited to a single concept or single embodiment or single invention.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method for electronic gimbal video stabilizing, comprising:
determining, by one or more processors, one or more parameters of an extended image space formed by two or more cameras, each of the two or more cameras having a lens and an image sensor, the two or more cameras being in a fixed position relative to each other and generating overlapping images, wherein the extended image space defines a real-time panoramic video image created from image data generated by the two or more cameras;
determining, by the one or more processors, a bounding box within the extended image space based on a physical position and a predetermined orientation of the two or more cameras; and
updating, in real-time, a scan-line setting of image sensors that generate image data within the bounding box, wherein bounding box parameters are based on the one or more parameters of the extended image space and a position of the bounding box in the extended image space.

2. The method of claim 1, wherein image data determined by the bounding box is displayed on a screen as a video image.

3. The method of claim 1, wherein a position of a bounding box in extended image space is determined by an inference phase of machine learning.

4. The method of claim 3, wherein the machine learning comprises at least one of neural network learning and/or reinforcement learning.

5. The method of claim 1, wherein one or more parameters of the extended image space are determined by an inference phase of machine learning.

6. The method of claim 5, wherein the machine learning comprises at least one of neural network learning and/or reinforcement learning.

7. The method of claim 6, wherein a training phase of machine learning involves at least 100 different scenes and each scene is associated with one or more camera settings.

8. The method of claim 1, wherein the bounding box is based on data provided by a Inertial Measurement Unit (IMU).

9. The method of claim 1, wherein the bounding box is based on data provided by an object tracking algorithm.

10. The method of claim 1, wherein the bounding box is determined independently of scene content and is based on one or more camera settings.

11. An electronic gimbal video device comprising:
two or more cameras, each having a lens and an image sensor, the two or more cameras being in a fixed position relative to each other and enabled to generate overlapping images; and
one or more processors configured to perform instructions that implement the steps:
determining one or more parameters of an extended image space that defines a real-time panoramic video image of the image data generated by the two or more cameras;
determining a bounding box within the extended image space based on a physical position and a predetermined orientation of the two or more cameras; and
updating, in real-time, a scan-line setting of the image sensors that generate image data within the bounding box, wherein the bounding box is based on the one or more parameters of the extended image space and a position of the bounding box in the extended image space.

12. The device of claim 11, wherein the scan-line setting is based on an edge of the bounding box.

13. The device of claim 11, wherein a position of a bounding box in extended image space is determined by an inference phase of machine learning.

14. The device of claim 13, wherein the machine learning comprises at least one of neural network learning and/or reinforcement learning.

15. The device of claim 11, wherein one or more parameters of the extended image space are determined by an inference phase of machine learning and one or more camera settings.

16. The device of claim 15, wherein the machine learning comprises at least one of neural network learning and/reinforcement learning.

17. The device of claim 16, wherein a training phase of machine learning involves at least 100 different scenes and each scene is associated with one or more camera parameters.

18. The device of claim 11, wherein the bounding box is based on data provided by a Inertial Measurement Unit (IMU).

19. The device of claim 11, wherein the bounding box is based on data provided by an object tracking algorithm.

20. The device of claim 11, wherein the extended image space enables a Field of Vision (FoV) of at least 170 degrees in one dimension.
